(19) United States
(12) Patent Application Publication
(10) Pub. No.: US 2025/0247620 A1
(43) Pub. Date: Jul. 31, 2025

(54) SHAKE CORRECTION DEVICE, OPERATION METHOD FOR SHAKE CORRECTION DEVICE, OPERATION PROGRAM FOR SHAKE CORRECTION DEVICE, AND IMAGING APPARATUS

(71) Applicant: FUJIFILM Corporation, Tokyo (JP)

(72) Inventors: Masahito SAITO, Saitama-shi (JP); Taku YAMASHITA, Saitama-shi (JP)

(73) Assignee: FUJIFILM Corporation, Tokyo (JP)

(21) Appl. No.: 19/034,569

(22) Filed: Jan. 23, 2025

(30) Foreign Application Priority Data
Jan. 29, 2024 (JP) 2024-011055

(51) Int. Cl. H04N 23/68; H04N 23/667

(52) U.S. Cl. CPC H04N 23/687; H04N 23/667

(57) ABSTRACT

A shake correction device includes a stationary member that is fixed to a camera body of a digital camera, a movable member, housing portions, and a shake correction control unit. An imaging element is mounted on the movable member, and the movable member is disposed to face the stationary member with balls interposed therebetween. The movable member is moved relative to the stationary member according to the rolling of the balls to perform shake correction. The housing portions are provided on the movable member and house the balls to allow the balls to roll. The shake correction control unit performs an operation of moving the movable member along a set trajectory, which is a non-circular trajectory, for at least one period as a pre-operation of the shake correction.

### CROSS-REFERENCE TO RELATED APPLICATIONS

The present application claims priority under 35 U.S.C. § 119 to Japanese Patent Application No. 2024-011055 filed on Jan. 29, 2024. The above application is hereby expressly incorporated by reference, in its entirety, into the present application.

### BACKGROUND

### 1. Technical Field

The technique of the present disclosure relates to a shake correction device, an operation method for the shake correction device, an operation program for the shake correction device, and an imaging apparatus.

A shake correction device disclosed in JP2015-227944A includes a movable member that is movable relative to a stationary member, a shake correction member that is provided on the movable member and corrects a shake of an image formed by an optical system, and a plurality of drive members that move the movable member along each drive shaft on a plane orthogonal to an optical axis of the optical system. In the shake correction device disclosed in JP2015-227944A, a plurality of drive members are disposed such that an orthogonal angle between a line, which connects a center of the drive member and a center of the shake correction member, and a drive shaft of the drive member is 10 degrees or more.

An image shake correction device disclosed in JP2009-025481A is a device that holds a lens or a lens group, which forms a part of an imaging optical system, to allow the lens or the lens group to rotate and oscillate and causes the lens or the lens group to rotate and oscillate with respect to an optical axis of the imaging optical system according to a rotation/oscillation target value for correcting an image shake. The image shake correction device disclosed in JP2009-025481A comprises a lens holding member, a support unit, a drive unit, a detection sensor, and a drive control unit. The lens holding member includes a spherical surface portion that shares a center and has a constant curvature radius, and a lens holding portion that holds the lens or the lens group such that an optical axis of the lens or the lens group coincides with a central axis of the spherical surface portion. The support unit positions a center of the spherical surface portion of the lens holding member on the optical axis of the imaging optical system and supports the lens holding member to allow the lens holding member to rotate and oscillate about the center of the spherical surface portion as a center of oscillation. The drive unit generates a magnetic attractive force between the lens holding member and the support unit in a direction along the optical axis of the imaging optical system to drive the lens holding member in two axial directions orthogonal to the optical axis of the imaging optical system. The detection sensor detects a movement distance of the lens holding member from the optical axis of the imaging optical system in a plane orthogonal to the optical axis of the imaging optical system. The drive control unit controls the drive unit according to a detection output of the detection sensor to drive the lens holding member to a position corresponding to the rotation/oscillation target value.

A shake correction unit disclosed in WO2022-180976A is a shake correction unit that is built in a body of an imaging apparatus. The shake correction unit disclosed in WO2022-180976A comprises an imaging element that includes an imaging surface for imaging a subject and a back surface opposite to the imaging surface, a circuit board that is mounted on the back surface and includes an opening formed therein to expose a part of the back surface, and a first heat conductive member and a second heat conductive member to which driving heat of the imaging element is conducted. The first heat conductive member is connected to the second heat conductive member, and has elasticity higher than the elasticity of the second heat conductive member. The second heat conductive member is connected to the back surface via the opening.

### SUMMARY

One embodiment according to the technique of the present disclosure provides a shake correction device, an operation method for the shake correction device, an operation program for the shake correction device, and an imaging apparatus capable of performing a pre-operation with a smaller impact than in the related art to reduce a concern that a malfunction of shake correction caused by a position of a ball interposed between a stationary member and a movable member in a housing portion may occur.

A shake correction device according to an aspect of the present disclosure comprises: a stationary member that is fixed to a body of an imaging apparatus; a movable member on which an imaging element is mounted and which is disposed to face the stationary member with a ball interposed therebetween and is moved relative to the stationary member according to rolling of the ball to perform shake correction; an housing portion that is provided on at least one of the stationary member or the movable member and houses the ball to allow the ball to roll; and a processor. The processor performs an operation of moving the movable member along a set trajectory, which is a non-circular trajectory, for at least one period as a pre-operation of the shake correction.

It is preferable that the set trajectory is a trajectory which is other than a circular trajectory centered on a movement origin of the movable member and in which an amount of change in angle is smaller than that in a case where the movable member reaches the circular trajectory from the movement origin in a shortest distance and is moved along the circular trajectory.

It is preferable that the movable member is moved relative to the stationary member in a first direction and a second direction intersecting the first direction according to the rolling of the ball to perform the shake correction, and the processor performs an operation of moving the movable member in the first direction according to a first drive waveform and moving the movable member in the second direction according to a second drive waveform corresponding to the first drive waveform, as the pre-operation.

It is preferable that the set trajectory is an oblique linear trajectory inclined with respect to the first direction and the second direction.

It is preferable that the set trajectory is a trajectory passing through the movement origin.

It is preferable that the housing portion has a rectangular shape of which two sides orthogonal to each other are along the first direction and the second direction in a plan view, and the set trajectory is an oblique linear trajectory along a diagonal line of the rectangular housing portion.

It is preferable that the housing portion has a square shape of which two sides orthogonal to each other have the same length and are along the first direction and the second direction in a plan view, and the set trajectory is an oblique linear trajectory that is inclined by an angle of 45° with respect to the first direction and the second direction along a diagonal line of the square housing portion.

It is preferable that the set trajectory is an oblique elliptical trajectory inclined with respect to the first direction and the second direction.

It is preferable that amplitudes of the first drive waveform and the second drive waveform are set according to a range in which the movable member is movable under a control of the processor.

It is preferable that amplitudes of the first drive waveform and the second drive waveform are set according to a result of a sensory test for an impact caused by the pre-operation.

It is preferable that frequencies of the first drive waveform and the second drive waveform are set according to a result of a sensory test for a time taken for the pre-operation.

It is preferable that frequencies of the first drive waveform and the second drive waveform are set according to a result of a sensory test for an impact caused by the pre-operation.

It is preferable that the first drive waveform and the second drive waveform are sine waves.

It is preferable that the processor performs the pre-operation at at least one timing of a case where power is applied to the imaging apparatus, a case where an impact equal to or larger than a set value is detected, a case where a live view image is not displayed on a monitor of the imaging apparatus, a case where an imaging mode is switched in the imaging apparatus, a case where a function of the shake correction is turned on and/or off in the imaging apparatus, a case where an instruction to perform the pre-operation is given by a user, and every set interval.

It is preferable that a movement origin of the movable member is at least one of a center of a range in which the movable member is movable under a control of the processor, an optical center of a lens of the imaging apparatus, or a center of a mount portion on which the lens is mounted.

It is preferable that the movable member is capable of being moved by a voice coil motor, and a movement origin of the movable member is a magnetic origin that is a position at which an influence of a magnetic field of the voice coil motor is relatively small.

It is preferable that the imaging apparatus has a special imaging mode in which the movable member is moved to a plurality of positions by a short movement distance in units of pixels of the imaging element, images are captured at the plurality of positions, and a high-resolution image is generated from the plurality of obtained images, and the processor sets the movement origin as the magnetic origin in a case where an imaging mode is switched to the special imaging mode in the imaging apparatus.

There is provided an operation method for a shake correction device including a stationary member that is fixed to a body of an imaging apparatus, a movable member on which an imaging element is mounted and which is disposed to face the stationary member with a ball interposed therebetween and is moved relative to the stationary member according to rolling of the ball to perform shake correction, and an housing portion that is provided on at least one of the stationary member or the movable member and houses the ball to allow the ball to roll. The operation method comprises: performing an operation of moving the movable member along a set trajectory, which is a non-circular trajectory, for at least one period as a pre-operation of the shake correction.

There is provided an operation program for a shake correction device including a stationary member that is fixed to a body of an imaging apparatus, a movable member on which an imaging element is mounted and which is disposed to face the stationary member with a ball interposed therebetween and is moved relative to the stationary member according to rolling of the ball to perform shake correction, and an housing portion that is provided on at least one of the stationary member or the movable member and houses the ball to allow the ball to roll. The operation program causes a computer to execute processing comprising performing an operation of moving the movable member along a set trajectory, which is a non-circular trajectory, for at least one period as a pre-operation of the shake correction.

An imaging apparatus according to an aspect of the present disclosure comprises the shake correction device.

### BRIEF DESCRIPTION OF THE DRAWINGS

Exemplary embodiments according to the technique of the present disclosure will be described in detail based on the following figures, wherein:

FIG. 1 is a diagram showing a digital camera and a shake correction unit;

FIG. 2 is a front exploded perspective view of the shake correction unit;

FIG. 3 is a rear exploded perspective view of the shake correction unit;

FIG. 4 is a plan view of a periphery of a housing portion;

FIG. 5 is a block diagram showing an internal configuration of a digital camera;

FIG. 6 is a block diagram showing a detailed configuration of a control unit;

FIG. 7 is a block diagram showing a processing unit of a CPU;

FIG. 8 is a diagram showing a state where a ball is in contact with a wall surface of a housing portion and a position of a movable member defined by a control signal provided to a shake correction driver in the state and an actual position of the movable member;

FIG. 9 is a diagram showing a first drive waveform and a second drive waveform in the related art;

FIG. 10 is a diagram showing a set trajectory in the related art;

FIG. 11 is a diagram showing a position of a ball at each point on the set trajectory in the related art;

FIG. 12 is a diagram showing a first drive waveform and a second drive waveform of an example;

FIG. 13 is a diagram showing a set trajectory of this example;

FIG. 14 is a diagram showing a position of a ball at each point on a set trajectory of this example;

FIG. 15 is a diagram showing minimum values of amplitudes of a first drive waveform and a second drive waveform;

FIG. 16 is a diagram showing minimum values of frequencies of a first drive waveform and a second drive waveform;

FIG. 17 is a diagram showing maximum values of amplitudes and frequencies of a first drive waveform and a second drive waveform;

FIG. 18 is a flowchart showing a processing procedure of the digital camera;

FIG. 19 is a diagram showing a rectangular housing portion having an aspect ratio of 3:4;

FIG. 20 is a diagram showing a first drive waveform and a second drive waveform in a case of the housing portion shown in FIG. 19;

FIG. 21 is a diagram showing a set trajectory generated by the first drive waveform and the second drive waveform shown in FIG. 20;

FIG. 22 is a diagram showing modification examples of the first drive waveform and the second drive waveform;

FIG. 23 is a diagram showing a set trajectory generated by the first drive waveform and the second drive waveform shown in FIG. 22;

FIG. 24 is a diagram showing a modification example of a timing at which a pre-operation is performed;

FIG. 25 is a diagram showing a modification example of a timing at which a pre-operation is performed;

FIG. 26 is a diagram showing a modification example of a timing at which a pre-operation is performed;

FIG. 27 is a diagram showing a modification example of a timing at which a pre-operation is performed;

FIG. 28 is a diagram showing a modification example of a timing at which a pre-operation is performed;

FIG. 29 is a diagram showing a modification example of a timing at which a pre-operation is performed;

FIG. 30 is a diagram showing a modification example of a timing at which a pre-operation is performed;

FIG. 31 is a diagram illustrating a special imaging mode; and

FIG. 32 is a diagram showing an aspect in which a movement origin of a movable member is set as a magnetic origin in a case where an imaging mode is switched to the special imaging mode.

### DETAILED DESCRIPTION

An example of an embodiment of a technique of the present disclosure will be described below with reference to the drawings.

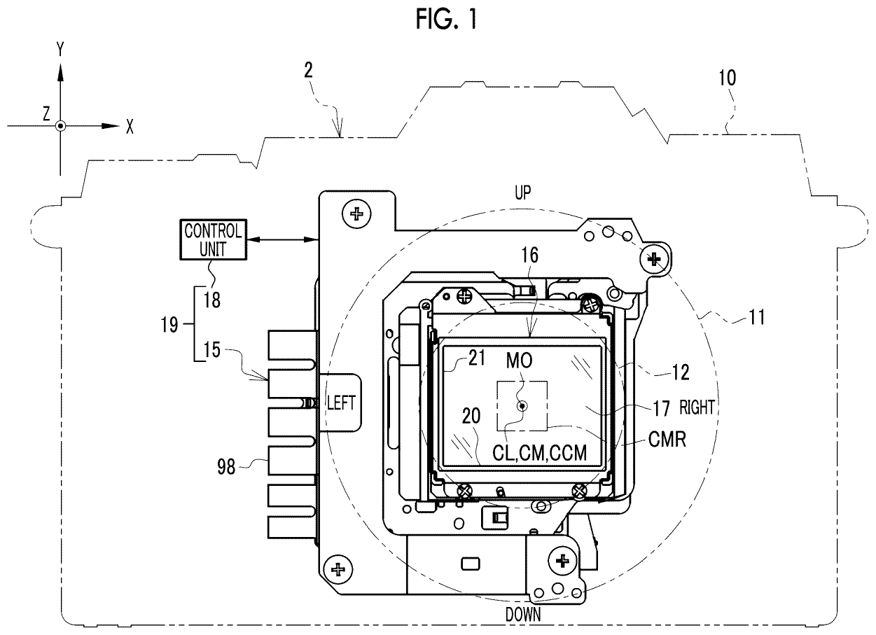

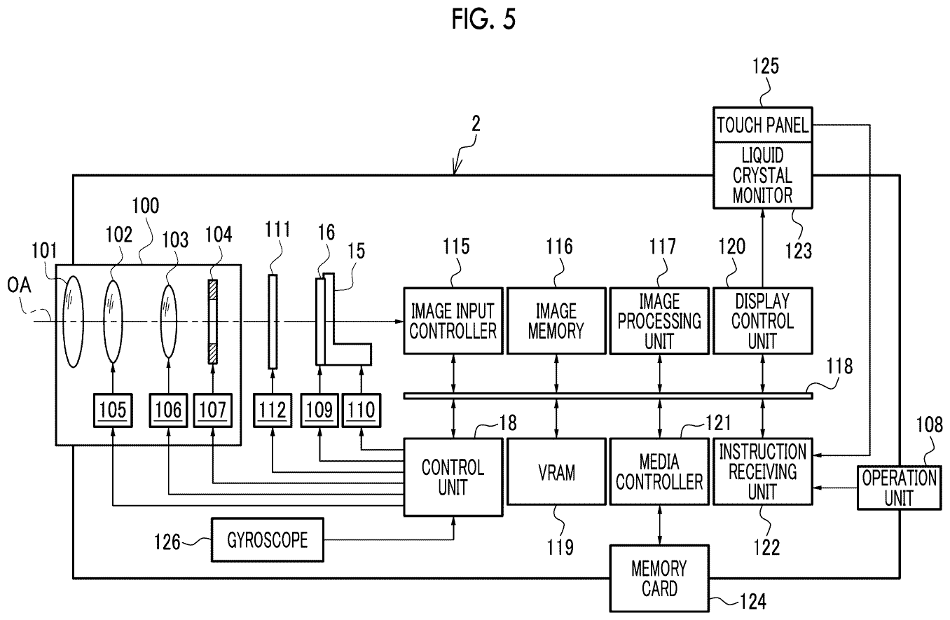

For example, as shown in FIG. 1, a digital camera 2 comprises a camera body 10. A mount portion 11 is provided on a front surface of the camera body 10. The mount portion 11 includes a circular imaging aperture 12. An interchangeable lens 100 (see FIG. 5) is attachably and detachably mounted on the mount portion 11. The digital camera 2 is an example of an “imaging apparatus” according to the technique of the present disclosure. Further, the camera body 10 is an example of a “body” according to the technique of the present disclosure.

A shake correction unit 15 is built in the camera body 10. An imaging element 16 is mounted on the shake correction unit 15. The imaging element 16 is, for example, a complementary metal oxide semiconductor (CMOS) image sensor or a charge coupled device (CCD) image sensor. The imaging element 16 includes a rectangular imaging surface 17 that images a subject. The imaging surface 17 receives subject light that indicates the subject. As well known, pixels, which photoelectrically convert the received subject light and output electrical signals, are two-dimensionally arranged on the imaging surface 17. The entire imaging surface 17 is exposed to the outside through the imaging aperture 12.

A control unit 18 is connected to the shake correction unit 15. The control unit 18 controls the operation of the shake correction unit 15. The shake correction unit 15 and the control unit 18 form a shake correction device 19.

The shake correction device 19 has a shake correction function. The shake correction function is a function to suppress misregistration caused by vibration applied to the camera body 10, that is, relative misregistration between the subject light incident on the imaging surface 17 and the digital camera 2. Examples of the vibration applied to the camera body 10 include a camera shake that is caused by a user who images a subject while holding the camera body 10, and the like.

The imaging element 16 is moved by the shake correction function under the control of the control unit 18 in a direction in which misregistration is canceled by a distance that is required to cancel the misregistration. More specifically, the imaging element 16 is moved by the shake correction function in an X-axis direction that is parallel to a long side 20 of the imaging surface 17 of the imaging element 16 and/or a Y-axis direction that is orthogonal to the long side 20, that is, parallel to a short side 21 intersecting the long side 20 at an angle of 90°. The X-axis direction is a horizontal direction in a case where a bottom surface of the camera body 10 is placed on a horizontal plane, and is also a width direction of the camera body 10. The X-axis direction is an example of a “first direction” according to the technique of the present disclosure. Further, the Y-axis direction is a vertical direction in a case where the bottom surface of the camera body 10 is placed on the horizontal plane, and is also a height direction of the camera body 10. The Y-axis direction is an example of a “second direction” according to the technique of the present disclosure. Terms related to an angle, such as “orthogonal” and “90°” include not only the meanings of “perfectly orthogonal”, “exact 90°”, and the like but also the meanings of “substantially orthogonal”, “about 90°”, and the like that include an error allowed in design and manufacturing, for example, an error of about ±10% of a design value. Furthermore, the term “parallel” also includes not only the meaning of “perfectly parallel” but also the meaning of “substantially parallel” that includes an error allowed in design and manufacturing, for example, an error of about ±10% of a design value. In the following description, a side corresponding to the long side 20 is expressed as “down”, and a side opposite to the long side 20 in the Y-axis direction is expressed as “up”. In addition, a side corresponding to the short side 21 is expressed as “left”, and a side opposite to the short side 21 in the X-axis direction is referred to as “right”.

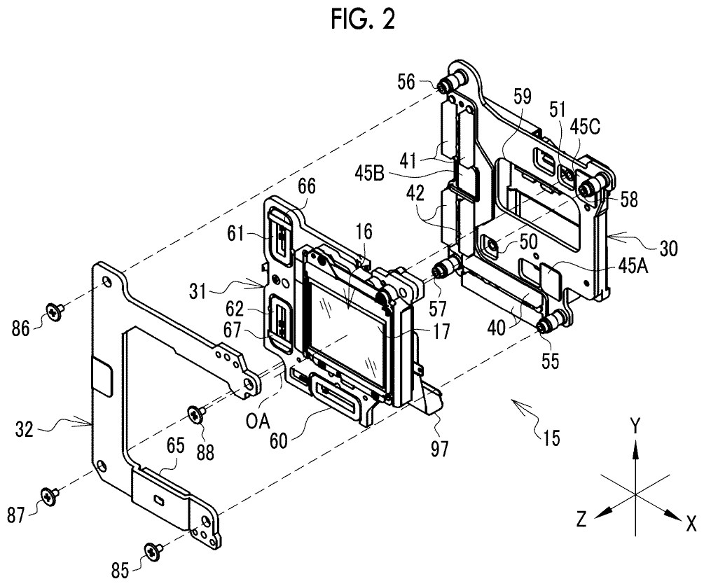

Here, in this specification, the “misregistration” caused by vibration applied to the camera body 10 refers to a phenomenon that occurs in a case where the position of an optical axis OA (see FIG. 2) varies with respect to the subject due to vibration. The “optical axis OA” refers to an optical axis of subject light that is incident on the imaging surface 17 through the lens 100. The variation of the position of the optical axis OA means that the optical axis OA is tilted with respect to a reference axis (for example, an optical axis OA obtained in a case where misregistration does not occur yet) due to misregistration. In this specification, canceling misregistration includes not only the meaning of “removing misregistration” but also the meaning of “reducing misregistration”.

A center CL of the lens 100 through which the optical axis OA passes is an example of an “optical center of a lens” according to the technique of the present disclosure. In the digital camera 2, the center CL of the lens 100 and a center CM of the mount portion 11 coincide with each other. Further, the center CL of the lens 100 and a center CCM of a movable range (hereinafter, referred to as a control movable range) CMR in which the imaging element 16 is movable in the X-axis direction and the Y-axis direction under the control of the control unit 18 coincide with each other. In summary, in the digital camera 2, the center CL of the lens 100, the center CM of the mount portion 11, and the center CCM of the control movable range CMR of the imaging element 16 coincide with each other. A movement origin MO of the imaging element 16, which is an initial position of the imaging element 16 in a case where misregistration does not occur and the shake correction function is not in operation, coincides with the center CL of the lens 100, the center CM of the mount portion 11, and the center CCM of the control movable range of the imaging element 16. The term “coincide” includes not only the meaning of “perfectly coinciding” but also the meaning of “substantially coinciding” that includes an error allowed in design and manufacturing, for example, an error of about ±10% of a design value. Similarly, the term “the same” also includes not only the meaning of “completely the same” but also the meaning of “substantially the same” that includes an error allowed in design and manufacturing, for example, an error of about ±10% of a design value.

The control movable range CMR can also refer to a movable range of the imaging element 16 in an XY plane under the control of the control unit 18. The control movable range CMR is a range that is the same as or slightly smaller than a range in which the imaging element 16 is mechanically movable in the X-axis direction and the Y-axis direction. The control movable range CMR of this example has a square shape of which two sides orthogonal to each other have the same length and are along the X-axis direction and the Y-axis direction. The term “along” includes not only the meaning of “perfectly along” but also the meaning of “substantially along” that includes an error allowed in design and manufacturing, for example, an error of about ±10% of a design value.

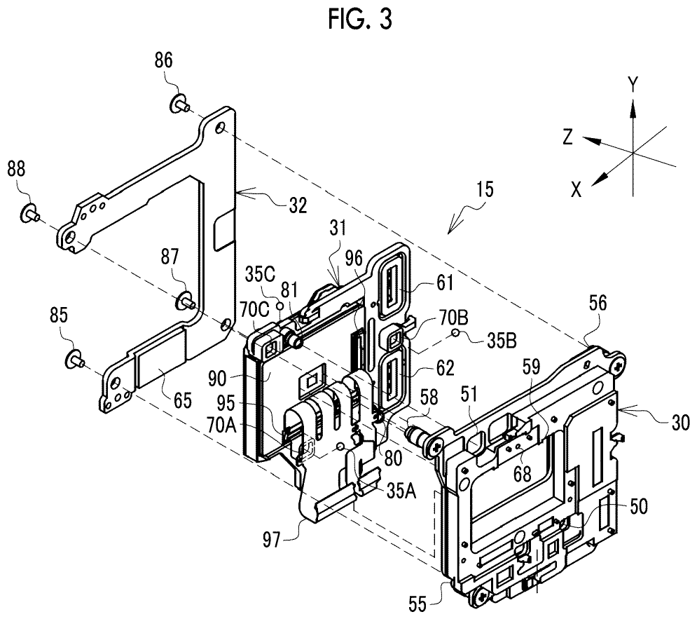

For example, as shown in FIGS. 2 and 3, the shake correction unit 15 comprises a stationary member 30, a movable member 31, a yoke 32, and the like. The stationary member 30 is disposed on a rear side of the camera body 10, and the yoke 32 is disposed on a front side of the camera body 10. The stationary member 30 is fixed to the camera body 10. That is, the position of the stationary member 30 is fixed within the camera body 10. Further, the stationary member 30 and the yoke 32 are fixed to each other with an interval therebetween in a Z-axis direction that is orthogonal to an X axis and a Y axis and is parallel to the optical axis OA. The movable member 31 is disposed between the stationary member 30 and the yoke 32 via three balls 35A, 35B, and 35C having the same size. The movable member 31 can be moved in the X-axis direction and the Y-axis direction (rotated about a Z axis) with respect to the stationary member 30 and the yoke 32 by the balls 35A to 35C. The shake correction function is realized by the stationary member 30, the movable member 31, and the balls 35A to 35C. In the following description, the balls 35A to 35C may be collectively referred to as the balls 35 in a case where the balls 35A to 35C do not need to be particularly distinguished from each other. Similarly to the X-axis direction, the Z-axis direction is a horizontal direction in a case where the bottom surface of the camera body 10 is placed on the horizontal plane. Furthermore, the Z-axis direction is also a depth direction of the camera body 10.

The stationary member 30 holds a magnet 40, a magnet 41, and a magnet 42. The magnets 40 to 42 are mounted on a front surface of the stationary member 30 facing the movable member 31. Each of the magnets 40 to 42 is a set of a sheet-like magnet of which an N pole faces the movable member 31 and a sheet-like magnet of which an S pole faces the movable member 31. The magnet 40 is disposed in the middle of a lower portion of the stationary member 30 such that a long side of the magnet 40 is along the X-axis direction. The magnet 41 and the magnet 42 are arranged in the Y-axis direction. The magnet 41 is disposed at an upper left corner of the stationary member 30 such that a long side of the magnet 41 is along the Y-axis direction. The magnet 42 is disposed at a lower left corner of the stationary member 30 such that a long side of the magnet 42 is along the Y-axis direction.

Plates 45A, 45B, and 45C are mounted on the front surface of the stationary member 30 in addition to the magnets 40 to 42. The plate 45A is disposed above the magnet 40 at a lower right corner of the stationary member 30. The plate 45B is disposed between the magnets 41 and 42 on the left side of the stationary member 30. The plate 45C is disposed at an upper right corner of the stationary member 30. The plate 45A supports the ball 35A to allow the ball 35A to roll, the plate 45B supports the ball 35B to allow the ball 35B to roll, and the plate 45C supports the ball 35C to allow the ball 35C to roll. In the following description, the plates 45A to 45C may be collectively referred to as the plates 45 in a case where the plates 45A to 45C do not need to be particularly distinguished from each other.

A square restriction opening 50 and a square restriction opening 51, which restrict a mechanical movable range of the movable member 31 and, by extension, the imaging element 16 in the XY plane, are formed in the stationary member 30.

The sizes of the restriction openings 50 and 51, which are viewed in the Z-axis direction, are substantially the same. The restriction opening 50 is formed between the magnet 42 and the plate 45A at the lower left corner of the stationary member 30. The restriction opening 51 is formed at the upper right corner of the stationary member 30 to be adjacent to the left side of the plate 45C. That is, the restriction openings 50 and 51 are disposed at substantially diagonal positions in the stationary member 30.

A female screw 55, a female screw 56, a female screw 57, and a female screw 58 are provided on the stationary member 30 via spacers. The female screw 55 is provided at the lower right corner of the stationary member 30. The female screw 56 is provided at the upper left corner of the stationary member 30. The female screw 57 is provided at the lower left corner of the stationary member 30. The female screw 58 is provided at the upper right corner of the stationary member 30.

A relatively large rectangular access opening 59 is formed at a central portion of the stationary member 30. The access opening 59 is provided for access to a back surface of the movable member 31 from a back surface of the stationary member 30.

The movable member 31 holds the imaging element 16. The imaging element 16 is mounted on a central portion of the movable member 31. For this reason, expressions such as “moving the imaging element 16”, “the imaging element 16 is moved”, and “the movement origin of the imaging element 16” are synonymous with expressions such as “moving the movable member 31”, “the movable member 31 is moved”, and “a movement origin of the movable member 31”.

Further, the movable member 31 holds a coil 60, a coil 61, and a coil 62. The coil 60 is disposed at a position facing the magnet 40 in the Z-axis direction in the middle of a lower portion of the movable member 31. The coil 61 is disposed at a position facing the magnet 41 in the Z-axis direction at an upper left corner of the movable member 31. The coil 62 is disposed at a position facing the magnet 42 in the Z-axis direction at a lower left corner of the movable member 31. The coil 60 is disposed such that a long side of the coil 60 is along the X-axis direction. The coils 61 and 62 are arranged in the Y-axis direction. Each of the coils 61 and 62 is disposed such that a long side of each of the coils 61 and 62 is along the Y-axis direction.

A magnet 65 is held by the yoke 32. Further, a magnetic body 66 is mounted on the coil 61, and a magnetic body 67 is mounted on the coil 62. The magnet 65 is, for example, a neodymium magnet. The magnetic bodies 66 and 67 are, for example, thin plate pieces made of iron. The magnet 65 is disposed to cover the coil 60, and increases a drive force of the coil 60. The magnetic bodies 66 and 67 are arranged in the Y-axis direction. The magnetic body 66 is disposed on the upper end side of the coil 61, and the magnetic body 67 is disposed on the lower end side of the coil 62.

Since the coil 60 is disposed at a position facing the magnet 40 in the Z-axis direction as described above, the magnet 65 is also disposed at a position facing the magnet 40 in the Z-axis direction. For this reason, the magnet 65 is attracted to the magnet 40 in a state where the magnet 65 is fixed to the yoke 32.

Similarly, since the coil 61 is disposed at a position facing the magnet 41 in the Z-axis direction as described above, the magnetic body 66 is also disposed at a position facing the magnet 41 in the Z-axis direction. For this reason, the magnetic body 66 is attracted to the magnet 41. Further, since the coil 62 is disposed at a position facing the magnet 42 in the Z-axis direction as described above, the magnetic body 67 is also disposed at a position facing the magnet 42 in the Z-axis direction. For this reason, the magnetic body 67 is attracted to the magnet 42.

Housing portions 70A, 70B, and 70C are formed on a rear surface of the movable member 31 facing the stationary member 30. The housing portion 70A is disposed at a position facing the plate 45A in the Z-axis direction at a lower right corner of the movable member 31. The housing portion 70B is disposed at a position facing the plate 45B in the Z-axis direction between the coils 61 and 62 disposed on the left side of the movable member 31. The housing portion 70C is disposed at a position facing the plate 45C in the Z-axis direction at an upper right corner of the movable member 31. The housing portion 70A houses the ball 35A to allow the ball 35A to roll, the housing portion 70B houses the ball 35B to allow the ball 35B to roll, and the housing portion 70C houses the ball 35C to allow the ball 35C to roll. The depths of the housing portions 70A to 70C in the Z-axis direction are slightly smaller than the diameters of the balls 35A to 35C, respectively. In the following description, the housing portions 70A to 70C may be collectively referred to as the housing portions 70 in a case where the housing portions 70A to 70C do not need to be particularly distinguished from each other.

A columnar protrusion 80, which protrudes toward the stationary member 30, is provided at a position facing the restriction opening 50 in the Z-axis direction on the rear surface of the movable member 31. Further, a columnar protrusion 81, which protrudes toward the stationary member 30, is provided at a position facing the restriction opening 51 in the Z-axis direction on the rear surface of the movable member 31. The protrusion 80 is inserted into the restriction opening 50. Further, the protrusion 81 is inserted into the restriction opening 51. For this reason, the protrusions 80 and 81 act as restriction pins that restrict the mechanical movable range of the movable member 31 in the XY plane.

The yoke 32 is, for example, a magnetic body, such as a thin plate made of iron, and has a substantially C-shape. The yoke 32 forms a magnetic circuit together with the magnets 40 to 42, and increases magnetic flux that is received by the coils 60 to 62.

A male screw 85, a male screw 86, a male screw 87, and a male screw 88 are mounted on the yoke 32. The male screws 85 to 88 are fastened and fixed to the female screws 55 to 58 of the stationary member 30. Accordingly, the stationary member 30 and the yoke 32 are fixed to each other and the movable member 31 is movably held between the stationary member 30 and the yoke 32.

The shake correction unit 15 comprises a pair of voice coil motors (VCMs). The pair of VCMs is a pair formed of a first VCM and a second VCM. The first VCM comprises a pair formed of the magnet 41 and the coil 61, a pair formed of the magnet 42 and the coil 62, and the yoke 32, and generates power that is used to move the movable member 31 in the X-axis direction. On the other hand, the second VCM comprises a pair formed of the magnet 40 and the coil 60 and the yoke 32, and generates power that is used to move the movable member 31 in the Y-axis direction. More specifically, the first VCM generates power that is used to move the movable member 31 in the X-axis direction with a magnetic force of the magnet 41, a current flowing through the coil 61, a magnetic force of the magnet 42, and a current flowing through the coil 62. Further, the second VCM generates power that is used to move the movable member 31 in the Y-axis direction with a magnetic force of the magnet 40 and a current flowing through the coil 60.

A rectangular circuit board 90 having substantially the same size as the imaging element 16 is mounted on a back surface of the imaging element 16 opposite to the imaging surface 17. The circuit board 90 is made of a resin, such as epoxy. Electric circuits, such as a control circuit, a drive circuit, and a power circuit for the imaging element 16, are mounted on the circuit board 90. A connector 95 is provided at a lower end of a back surface of the circuit board 90. Further, a connector 96 is provided at a left end of the back surface of the circuit board 90.

One end of a flexible board 97 is connected to the connector 95. The other end of the flexible board 97 is led out to a back side of the stationary member 30 through the access opening 59. The other end of the flexible board 97 is connected to the control unit 18, a power feed circuit (not shown) that feeds power from a battery, and the like. Further, one end of a flexible board 98 (see FIG. 1) is connected to the connector 96. The other end of the flexible board 98 wraps around a front surface of the movable member 31 and is connected to the imaging element 16. In summary, the other end of the flexible board 98 is connected to the imaging element 16, and one end of the flexible board 98 is connected to the connector 96. One end of the flexible board 97 is connected to the connector 95, and the control unit 18 and the like are connected to the other end of the flexible board 97. For this reason, the imaging element 16, the circuit board 90, the control unit 18, and the like are connected via the flexible board 98, the connector 96, the connector 95, and the flexible board 97.

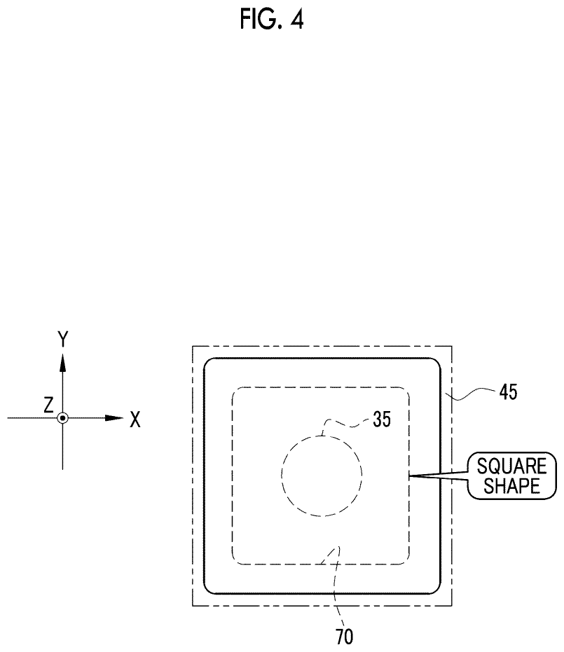

For example, as shown in FIG. 4, each housing portion 70 has a square shape of which two sides orthogonal to each other have the same length and are along the X-axis direction and the Y-axis direction in a plan view, that is, as viewed in the Z-axis direction. The length of the side of the housing portion 70 is, for example, about twice the diameter of the ball 35. Strictly speaking, the housing portion 70 has a substantially square shape of which four corners are subjected to round chamfering.

For example, as shown in FIG. 5, the lens 100 includes a plurality of types of lenses for forming a subject image on the imaging element 16. Specifically, the lens 100 includes an objective lens 101, a focus lens 102, and a zoom lens 103. These respective lenses 101 to 103 are arranged in this order from an object side (subject side) to an imaging side (imaging element 16 side). Although simplified in FIG. 5, each of the lenses 101 to 103 is actually a lens group in which a plurality of lenses are combined. The lens 100 also includes a stop 104. The stop 104 is disposed closest to the imaging side of the lens 100.

The focus lens 102 is provided with a focus lens driving mechanism 105, the zoom lens 103 is provided with a zoom lens driving mechanism 106, and the stop 104 is provided with a stop opening adjustment mechanism 107.

The focus lens driving mechanism 105 includes a focus cam ring that holds the focus lens 102 and includes a cam groove formed on an outer periphery thereof, a focus motor that rotates the focus cam ring around the optical axis OA to move the focus cam ring along the optical axis OA, a driver for the focus motor, and the like. Similarly, the zoom lens driving mechanism 106 includes a zoom cam ring that holds the zoom lens 103 and includes a cam groove formed on an outer periphery thereof, a zoom motor that rotates the zoom cam ring around the optical axis OA to move the zoom cam ring along the optical axis OA, a driver for the zoom motor, and the like. The focus cam ring and the zoom cam ring can also be manually rotated by a user from an outside of a lens barrel. That is, in the digital camera 2, the adjustment of a focus and the change of a focal length can be electrically performed by the focus motor and the zoom motor or can be manually performed by a user.

The stop 104 is, for example, an iris stop and is formed of a combination of a plurality of stop leaf blades. The stop leaf blades are simultaneously moved by a cam mechanism to open or close a central aperture formed by inner edges of the stop leaf blades, that is, to adjust the opening of the aperture, so that the stop 104 adjusts the amount of light passing therethrough. The stop opening adjustment mechanism 107 includes a stop motor that opens and closes the stop leaf blades, a driver for the stop motor, and the like. The stop 104 can also be manually opened and closed by a user. That is, in the digital camera 2, the adjustment of the opening of the stop 104 can be electrically performed by the stop motor or can be manually performed by a user.

Various motors, such as the focus motor, the zoom motor, and the stop motor, are, for example, stepping motors. In this case, a position of the focus lens 102 and a position of the zoom lens 103 on the optical axis OA and the opening of the stop 104 can be derived from drive amounts of the focus motor, the zoom motor, and the stop motor. A position sensor may be provided instead of using the drive amounts of the focus motor and the zoom motor to detect the position of the focus lens 102 and the position of the zoom lens 103.

Electrical components, such as the motors (the focus motor, the zoom motor, and the stop motor) or the drivers, of the respective driving mechanisms 105 to 107 are connected to the control unit 18. The electrical components of the respective driving mechanisms 105 to 107 are driven under the control of the control unit 18. More specifically, the control unit 18 outputs a drive signal corresponding to an instruction, which is input from a user via an operation unit 108, or the like to drive the electrical components of the respective driving mechanisms 105 to 107. For example, in a case where an instruction to change an angle of view to a telephoto side is input via an angle-of-view changing switch included in the operation unit 108, the control unit 18 outputs a drive signal to the driver for the zoom motor of the zoom lens driving mechanism 106 to move the zoom lens 103 to the telephoto side.

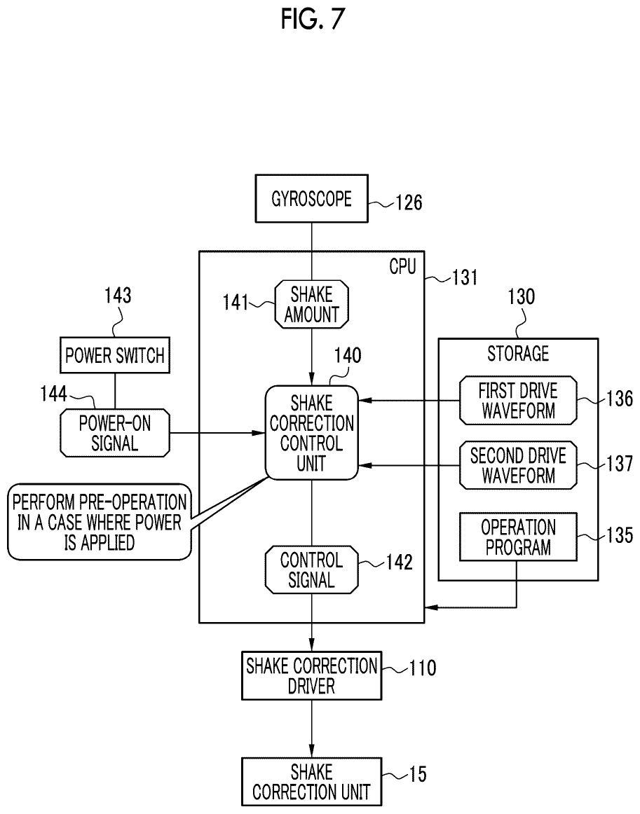

The operation unit 108 is a general term for members, which are operated by a user, such as a power switch 143 (see FIG. 7), a release button, a menu button, and a cross key. Here, the release button is a two-stage push button that can be halfway press-operated and fully press-operated. An instruction to prepare capturing of a static image or a video is given by a half-press operation of the release button, and an instruction to start capturing a static image or a video is given by a full-press operation of the release button.

The operation unit 108 also includes a mode selector switch that is used to switch an operation mode of the digital camera 2. The operation mode include a static image capturing mode, a video capturing mode, an image playback mode, a setting mode, and the like. The static image capturing mode includes not only a normal imaging mode in which one static image is captured but also a continuous imaging mode in which static images are continuously captured at a predetermined imaging interval, for example, a frame rate of 5 frames per second (fps) to 10 fps. The continuous imaging mode starts in a case where, for example, a full-pressing state of the release button continues for a time equal to or longer than a predetermined time (for example, 1 second or longer). The continuous imaging mode ends in a case where the full-pressing state of the release button is released.

The focus motor, the zoom motor, and the stop motor output the drive amounts to the control unit 18. The control unit 18 derives the position of the focus lens 102 and the position of the zoom lens 103 on the optical axis OA and the opening of the stop 104 from the drive amounts.

An imaging element driver 109 is connected to the imaging element 16. The imaging element driver 109 is connected to the control unit 18. The imaging element driver 109 supplies a vertical scanning signal, a horizontal scanning signal, and the like to the imaging element 16 under control of the control unit 18 to control a timing at which a subject image is captured by the imaging element 16.

A shake correction driver 110 is connected to the shake correction unit 15. The shake correction driver 110 is connected to the control unit 18. The shake correction driver 110 outputs a control signal 142 (see FIG. 7) output from the control unit 18 to an actuator, such as the voice coil motor of the shake correction unit 15, to cause the shake correction unit 15 to operate.

A shutter 111 is provided between the lens 100 and the imaging element 16. The shutter 111 is, for example, a focal plane shutter including a front curtain and a rear curtain. A shutter driving mechanism 112 is connected to the shutter 111. The shutter driving mechanism 112 includes an electromagnet that holds the front and rear curtains and releases the holding of the front and rear curtains to cause the front and rear curtains to travel, a driver for the electromagnet, and the like. The shutter driving mechanism 112 is driven under the control of the control unit 18 to open and close the shutter 111.

The control unit 18 is connected to respective parts, such as an image input controller 115, an image memory 116, and an image processing unit 117, through a busline 118. In addition, a video random access memory (VRAM) 119, a display control unit 120, a media controller 121, an instruction receiving unit 122, and the like are connected to the busline 118. Although not shown, a strobe drive control unit that controls the drive of a strobe device, an external communication interface (I/F) that communicates with an external device through a connection terminal such as a universal serial bus (USB) terminal, a wireless communication I/F that communicates with an external device through a wireless antenna, or the like is also connected to the busline 118.

Image data obtained from the capturing of a subject image is input to the image input controller 115 from the imaging element 16. The image input controller 115 outputs the image data to the image memory 116. The image memory 116 is, for example, a synchronous dynamic random access memory (SDRAM) and temporarily stores the image data.

The image processing unit 117 reads out unprocessed image data from the image memory 116. The image processing unit 117 performs various types of image processing on the image data. The various types of image processing are, for example, offset correction processing, sensitivity correction processing, pixel interpolation processing, white balance correction processing, gamma-correction processing, demosaicing, brightness signal and color difference signal generation processing, contour highlight processing, and color correction processing, and the like. The image processing unit 117 writes the image data, which has been subjected to the various types of image processing, back to the image memory 116.

The image data, which has been subjected to the various types of image processing and is to be displayed as a live view image (also referred to as a through-image), is input to the VRAM 119 from the image memory 116.

The VRAM 119 has an area that stores image data corresponding to two consecutive frames. The image data stored in the VRAM 119 is sequentially rewritten with new image data. The VRAM 119 sequentially outputs the newer image data of the image data corresponding to the two consecutive frames to the display control unit 120.

The display control unit 120 has a function of a so-called video encoder that converts the image data output from the VRAM 119 into video data and outputs the video data to a liquid crystal monitor 123 provided on a rear surface of the camera body 10. Accordingly, a user can visually recognize the live view image through the liquid crystal monitor 123. The display frame rate of the live view image is, for example, 60 fps.

In a case where an instruction to start capturing a static image or a video is given by the full-press operation of the release button, the image processing unit 117 performs compression processing on the image data of the image memory 116. In a case of the static image, the image processing unit 117 performs, for example, compression processing of a Joint Photographic Experts Group (JPEG) format on the image data. In a case of the video, the image processing unit 117 performs, for example, compression processing of a Moving Picture Experts Group (MPEG) format on the image data. The image processing unit 117 outputs the image data, which has been subjected to the compression processing, to the media controller 121.

The media controller 121 records the image data, which is output from the image processing unit 117 and has been subjected to the compression processing, in a memory card 124. The memory card 124 is attachably and detachably mounted in a memory card slot (not shown).

In a case where the image playback mode is selected through the mode selector switch of the operation unit 108, the media controller 121 reads out the image data from the memory card 124 and outputs the image data to the image processing unit 117. The image processing unit 117 performs expansion processing on the image data from the memory card 124. The image data subjected to the expansion processing is output to the display control unit 120. The display control unit 120 converts the image data into video data and outputs the video data to the liquid crystal monitor 123. Accordingly, a user can visually recognize a playback image through the liquid crystal monitor 123.

The instruction receiving unit 122 receives various operating instructions that are input from a user through the operation unit 108 and a touch panel 125 integrally provided with the liquid crystal monitor 123. The instruction receiving unit 122 outputs the received various operating instructions to the control unit 18 through the busline 118. The touch panel 125 overlaps with a display surface of the liquid crystal monitor 123. The touch panel 125 detects contact with a finger of a user or a dedicated indicator, such as a stylus pen, to recognize various operating instructions input from the user.

Gyroscopes 126 are connected to the control unit 18. The gyroscopes 126 are provided at predetermined positions in the camera body 10, for example, in a grip portion on which a right hand of a user is placed during imaging or the like. The gyroscopes 126 detect the amount of vibration (shake) applied to the camera body 10. The gyroscope 126 is prepared for each of three axes, that is, a pitch axis, a yaw axis, and a roll axis. In this example, the pitch axis is the X axis, the yaw axis is the Y axis, and the roll axis is the Z axis.

The gyroscope 126 for the pitch axis detects the amount of rotation about the X axis that is the pitch axis, that is, the amount of vertical vibration (vertical shake). The gyroscope 126 for the yaw axis detects the amount of rotation about the Y axis that is the yaw axis, that is, the amount of yaw vibration (yaw shake). The gyroscope 126 for the roll axis detects the amount of rotation about the Z-axis that is the roll axis, that is, the amount of horizontal vibration (horizontal shake). In the following description, the amount of vibration (shake) detected by the gyroscope 126 is referred to as a shake amount 141 (see FIG. 7).

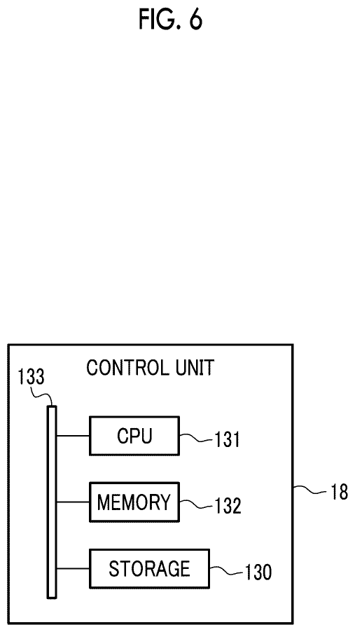

For example, as shown in FIG. 6, the control unit 18 comprises a storage 130, a central processing unit (CPU) 131, and a memory 132. The storage 130, the CPU 131, and the memory 132 are connected to each other through a busline 133. The control unit 18 is an example of a “computer” according to the technique of the present disclosure.

The storage 130 is, for example, a non-volatile storage device such as an electrically erasable programmable read-only memory (EEPROM). The storage 130 stores various programs, various types of data pertaining to the various programs, and the like. A ferroelectric random access memory (FeRAM) or a magnetoresistive random access memory (MRAM) may be used as the storage 130 instead of the EEPROM.

The memory 132 is a work memory that is used in a case where the CPU 131 performs processing. The CPU 131 loads the program stored in the storage 130 into the memory 132, and performs processing corresponding to the program. Accordingly, the CPU 131 comprehensively controls each part of the digital camera 2. The CPU 131 is an example of a “processor” according to the technique of the present disclosure. The memory 132 may be built in the CPU 131.

For example, as shown in FIG. 7, an operation program 135 is stored in the storage 130. The operation program 135 is a program for causing the CPU 131 to perform various types of control such as control of correcting a shake (hereinafter, referred to as shake correction control). That is, the operation program 135 is an example of an “operation program for a shake correction device” according to the technique of the present disclosure. A first drive waveform 136, a second drive waveform 137, and the like are also stored in the storage 130 in addition to the operation program 135.

In a case where the operation program 135 is activated, the CPU 131 functions as a shake correction control unit 140 in cooperation with the memory 132 and the like. The shake amount 141 is input to the shake correction control unit 140 from the gyroscope 126. The shake correction control unit 140 generates a control signal 142 that controls the operation of the shake correction unit 15 and corresponds to the shake amount 141. The shake correction control unit 140 outputs the control signal 142 to the shake correction driver 110.

The first drive waveform 136 and the second drive waveform 137 are input to the shake correction control unit 140. Further, in a case where the power switch 143 is operated by a user and power is applied to the digital camera 2, a power-ON signal 144 is input to the shake correction control unit 140 from the power switch 143. The shake correction control unit 140 performs a pre-operation of shake correction in a case where the power-ON signal 144 is input.

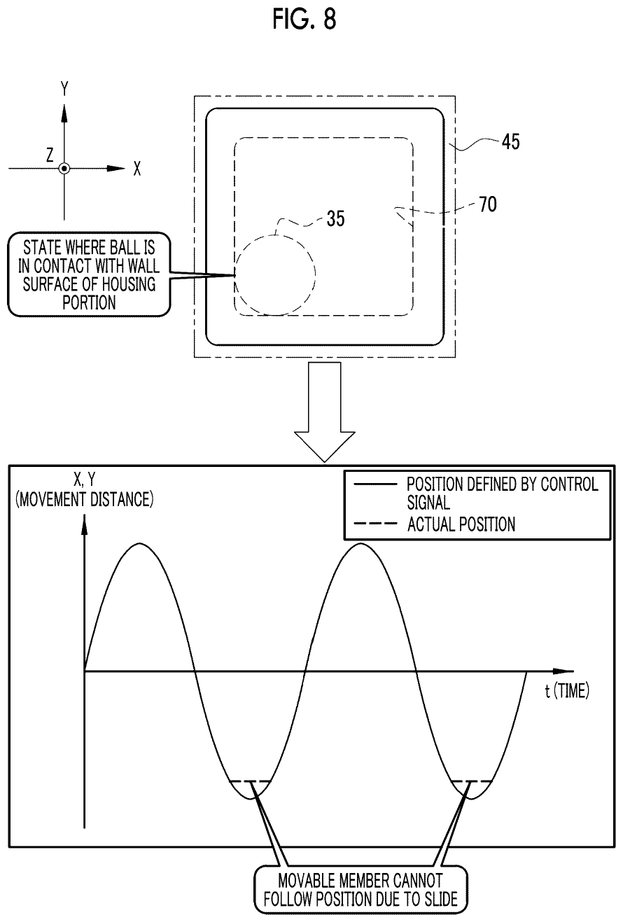

For example, in a case where shake correction control is started in a state where the ball 35 is in contact with a wall surface of the housing portion 70 as shown above an arrow in FIG. 8, there is a period in which the ball 35 is pushed against the wall surface of the housing portion 70 and slides on the plate 45 (moves while being dragged and sliding) without rolling on the plate 45. For this reason, a malfunction in which the movable member 31 cannot follow a position defined by the control signal 142 may occur as shown below the arrow. The pre-operation is an operation for reducing a concern that such a malfunction may occur. More specifically, the pre-operation is an operation of moving the imaging element 16 (movable member 31) in the X-axis direction according to the first drive waveform 136 and moving the imaging element 16 (movable member 31) in the Y-axis direction according to the second drive waveform 137 corresponding to the first drive waveform 136 at the same time.

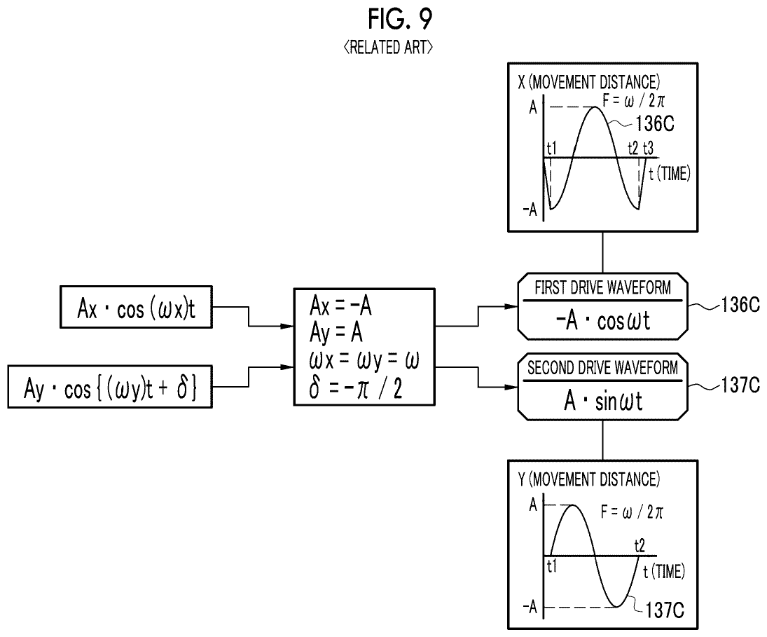

FIG. 9 shows a first drive waveform 136C and a second drive waveform 137C in the related art. The first drive waveform 136C is based on Ax·cos(ωx)t that is a cosine function representing a simple harmonic motion in the X-axis direction. Further, the second drive waveform 137C is based on Ay·cos{(ωy)t+δ} that is a cosine function representing a simple harmonic motion in the Y-axis direction. Ax and Ay denote amplitudes, ωx and ωy denote angular frequencies (also referred to as angular oscillation frequencies), t denotes time, and δ denote a phase difference.

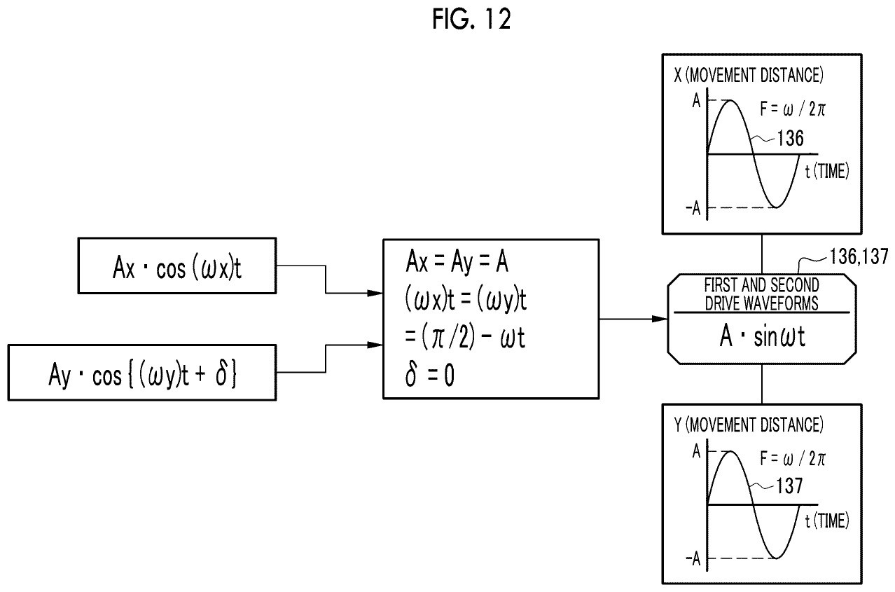

In the related art, Ax is set to −A, Ay is set to A, ωx and ωy are set to ω, and δ is set to −π/2. For this reason, the first drive waveform 136C is −A·cos ωt, and the second drive waveform 137C is A·sin ωt. More specifically, the first drive waveform 136C is a one-period portion of −A·cost and the second drive waveform 137C is a one-period portion of A·sin ωt. That is, both the first drive waveform 136C and the second drive waveform 137C are sine waves. In subsequent drawings (FIG. 12 and the like) including FIG. 9, graphs showing the first drive waveform 136 and the second drive waveform 137 are positive in a case where the movable member 31 is present on the right side of the movement origin MO, negative in a case where the movable member 31 is present on the left side of the movement origin MO, positive in a case where the movable member 31 is present on the upper side of the movement origin MO, and negative in a case where the movable member 31 is present on the lower side of the movement origin MO.

More specifically, the first drive waveform 136C is a composite waveform of a one-period portion of −A·cos ωt, a straight line having a gradient of −A/t1, and a straight line having a gradient of A/(t3−t2). Further, more specifically, the second drive waveform 137C is a one-period portion of A·sin ωt of which a start time is t1 and an end time is t2. t1 and (t3−t2) have the same value, and are, for example, several tens to several hundreds of milliseconds.

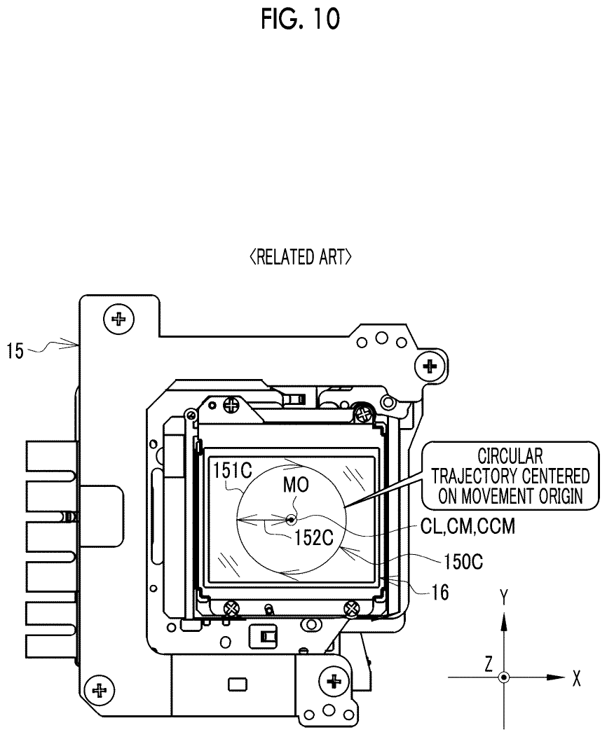

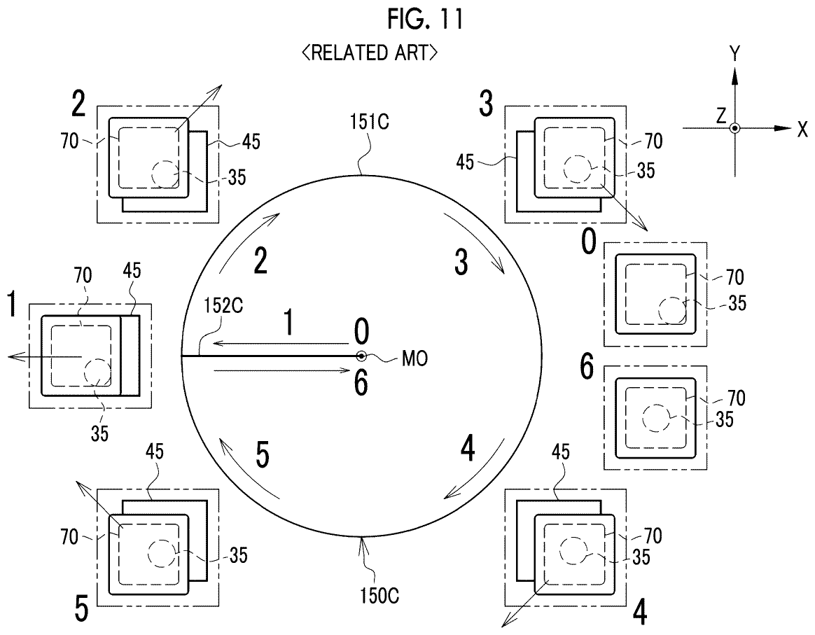

For example, as shown in FIGS. 10 and 11, a set trajectory 150C in the pre-operation in the related art is formed of a circular trajectory 151C that is centered on the movement origin MO and has a radius equal to the amplitude A, and a linear trajectory 152C that reaches from the movement origin MO to the circular trajectory 151C, reaches from the circular trajectory 151C to the movement origin MO, and is parallel to the X-axis direction. The circular trajectory 151C is a trajectory that is generated from the one-period portion of −A·cos ωt of the first drive waveform 136C and the one-period portion of A·sin ωt of the second drive waveform 137C. That is, the circular trajectory 151C is a type of a Lissajous figure that is a plane figure obtained from a combination of two simple harmonic motions orthogonal to each other. The circular trajectory 151C is a trajectory that allows the movable member 31 to move without a deviation in a movement distance in the vertical and horizontal directions. The linear trajectory 152C is a trajectory that is generated from a straight line having a gradient of −A/t1 of the first drive waveform 136C and a straight line having a gradient of A/(t3−t2). The linear trajectory 152C is a trajectory that reaches the circular trajectory 151C from the movement origin MO in the shortest distance.

FIG. 11 shows the entire process in which the ball 35 having been in contact with the wall surface of the housing portion 70 before the pre-operation is moved to a position away from the wall surface of the housing portion 70 in a case where the pre-operation is performed to move the movable member 31 along the set trajectory 150C. First, in a state 0 where the movable member 31 before the pre-operation is present at the movement origin MO, the ball 35 is in contact with a wall surface of a lower right corner of the housing portion 70. Next, in a state 1 until the pre-operation is started and the movable member 31 reaches the circular trajectory 151C from the movement origin MO along the linear trajectory 152C, the ball 35 is pushed against the wall surface of the housing portion 70 and slides on the plate 45 in the X-axis direction. In a state 2 where the movable member 31 is moved obliquely upward to the right along the circular trajectory 151C, the ball 35 is pushed against the wall surface of the housing portion 70 and slides on the plate 45 in the Y-axis direction. A movement distance of the ball 35 in a case where the ball 35 is pushed against the wall surface of the housing portion 70 and slides on the plate 45 is the same as a movement distance of the movable member 31.

In a state 3 where the movable member 31 is moved obliquely downward to the right along the circular trajectory 151C, a state 4 where the movable member 31 is moved obliquely downward to the left, and a state 5 where the movable member 31 is moved obliquely upward to the left, the ball 35 rolls on the plate 45 without being pushed against the wall surface of the housing portion 70. A movement distance of the ball 35 in a case where the ball 35 rolls on the plate 45 is a half of a movement distance of the movable member 31. For this reason, for example, in a case where the movable member 31 is moved by 1 cm in the X-axis direction and the ball 35 rolls on the plate 45 accordingly, the ball 35 is moved by 0.5 cm in the X-axis direction.

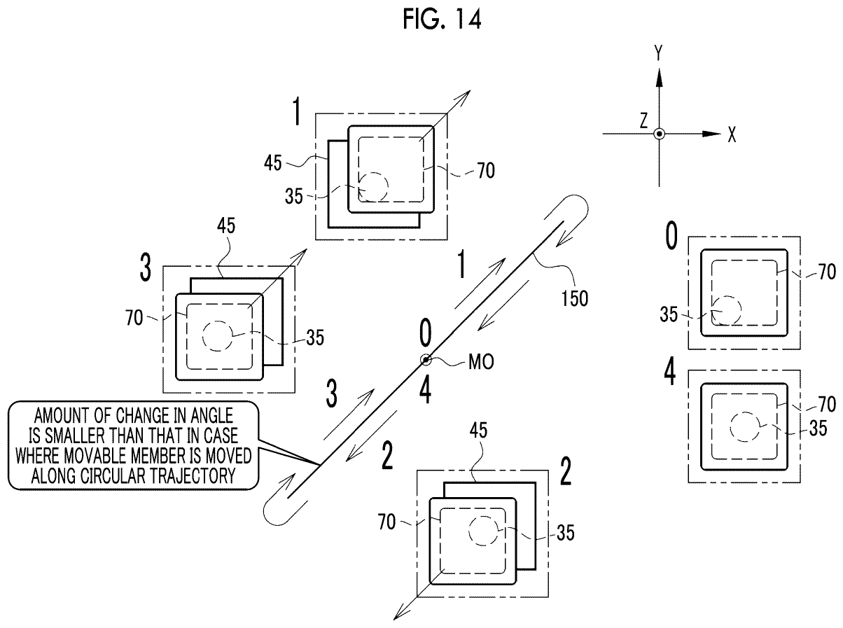

In a state 6 where the movable member 31 has returned to the movement origin MO from the circular trajectory 151C along the linear trajectory 152C, the ball 35 is moved to a position away from the wall surface of the lower right corner of the housing portion 70 by A/2 and is stopped. A case where the ball 35 is in contact with the wall surface of the lower right corner of the housing portion 70 before the pre-operation is performed is illustrated in FIG. 11, but the present disclosure is not limited thereto. Even in a case where the ball 35 is in contact with the wall surface of any corner of the housing portion 70 or any wall surface of the upper, lower, left, and right wall surfaces of the housing portion 70, the ball 35 is moved to a position away from the wall surface of the housing portion 70 and is stopped by the pre-operation. The same applies to the cases of FIG. 14 and the like to be described below.

Even though the pre-operation is performed, the ball 35 already present at a position away from the wall surface of the housing portion 70 before the pre-operation always rolls on the plate 45 without being pushed against the wall surface of the housing portion 70 and sliding on the plate 45 unlike in the states 1 and 2 shown in FIG. 11. In a case where the pre-operation is performed, the ball 35 already present at a position away from the wall surface of the housing portion 70 before the pre-operation returns to the original position before the pre-operation. That is, the position of the ball 35 already present at a position away from the wall surface of the housing portion 70 before the pre-operation does not change before and after the pre-operation. The same applies to the cases of FIG. 14 and the like to be described below.

In the set trajectory 150C in the related art, a change in the angle of the movable member 31 is close to 90° between a case where the movable member 31 is moved to the circular trajectory 151C from the linear trajectory 152C and a case where the movable member 31 is moved to the linear trajectory 152C from the circular trajectory 151C.

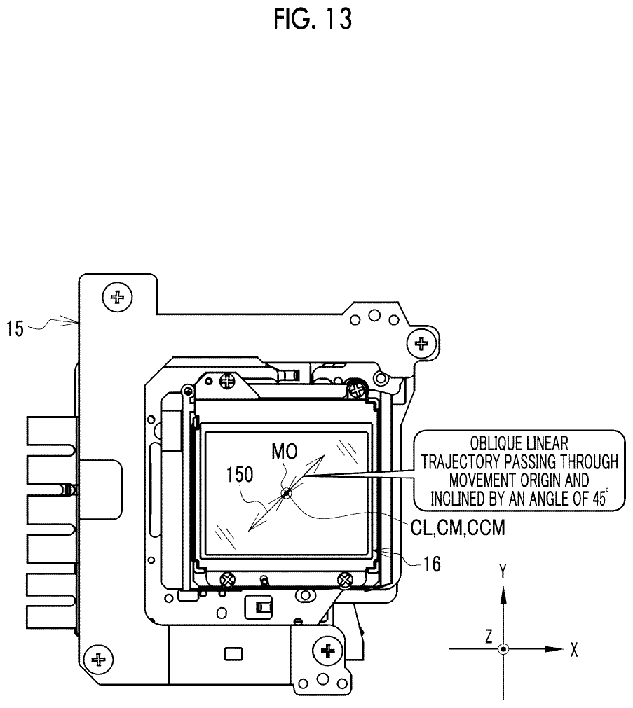

For this reason, the amount of change in the angle of the movable member 31 is relatively large, and an impact transmitted to the camera body 10 and, by extension, a user holding the camera body 10 is large accordingly. Since a user perceives that the pre-operation is being performed in a case where the impact is large, the user feels uncomfortable or suspects a failure, which is inconvenient. Therefore, in the technique of the present disclosure, there is provided a set trajectory 150 (see FIGS. 13 and 14) which has a non-circular shape and in which the amount of change in the angle of the movable member 31 is smaller than that in a case where the movable member 31 is moved along the set trajectory 150C. The “non-circular trajectory” includes all trajectories other than the circular trajectory 151C in the related art.

For example, as shown in FIG. 12, in the present embodiment, Ax and Ay are set to A, (ωx)t and (ωy)t are set to (π/2)−ωt, and δ is set to 0. For this reason, each of the first drive waveform 136 and the second drive waveform 137 is A·sin ωt. More specifically, each of the first drive waveform 136 and the second drive waveform 137 is a one-period portion of A·sin ωt.

For example, as shown in FIGS. 13 and 14, the set trajectory 150 in the pre-operation of the present embodiment is a trajectory that passes through the movement origin MO, and is an oblique linear trajectory that is inclined by an angle of 45° with respect to the X-axis direction and the Y-axis direction along a diagonal line of the square housing portion 70. The set trajectory 150 is a trajectory that is generated from a one-period portion of A·sin ωt of the first drive waveform 136 and the second drive waveform 137. That is, the set trajectory 150 is also a type of a Lissajous figure like the circular trajectory 151C in the related art, and is a trajectory that allows the movable member 31 to move without a deviation in a movement distance in the vertical and horizontal directions.

FIG. 14 shows the entire process in which the ball 35 having been in contact with the wall surface of the housing portion 70 before the pre-operation is moved to a position away from the wall surface of the housing portion 70 in a case where the pre-operation is performed to move the movable member 31 along the set trajectory 150. First, in a state 0 where the movable member 31 before the pre-operation is present at the movement origin MO, the ball 35 is in contact with a wall surface of a lower left corner of the housing portion 70. Next, in a state 1 where the pre-operation is started and the movable member 31 is moved obliquely upward to the right from the movement origin MO along the set trajectory 150, the ball 35 is pushed against the wall surface of the housing portion 70 and slides obliquely upward to the right on the plate 45.

In a state 2 where the movable member 31 is moved obliquely downward to the left along the set trajectory 150 and a state 3 where the movable member 31 is moved obliquely upward to the right, the ball 35 rolls on the plate 45 without being pushed against the wall surface of the housing portion 70. In a state 4 where the movable member 31 has returned to the movement origin MO along the set trajectory 150, the ball 35 is moved to a position away from the wall surface of the lower left corner of the housing portion 70 by A/2 and is stopped.

In the set trajectory 150 of the present embodiment, there is no large change in the angle, such as a change in the angle close to 90° in the case of the set trajectory 150C in the related art. For this reason, it can be said that the set trajectory 150 is a trajectory in which the amount of change in the angle is smaller than that in the set trajectory 150C.

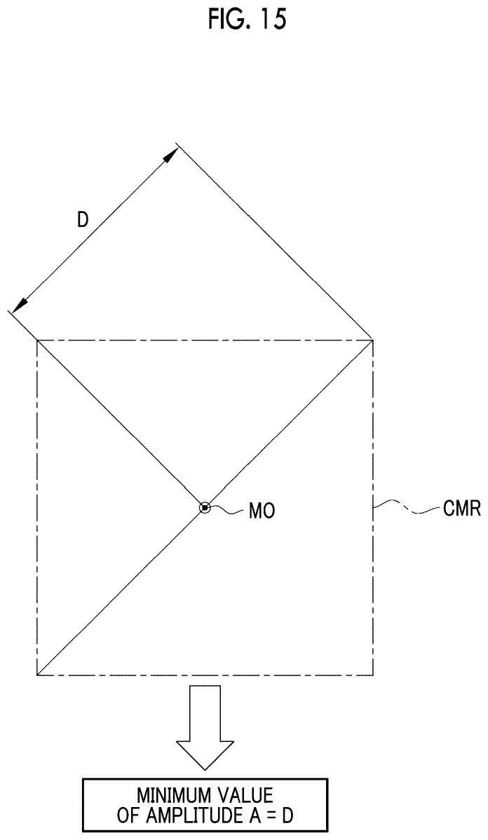

For example, as shown in FIG. 15, amplitudes A of the first drive waveform 136 and the second drive waveform 137 need to be larger than D that is half the length of a diagonal line of the control movable range CMR. That is, the amplitudes A of the first drive waveform 136 and the second drive waveform 137 are set according to the control movable range CMR.

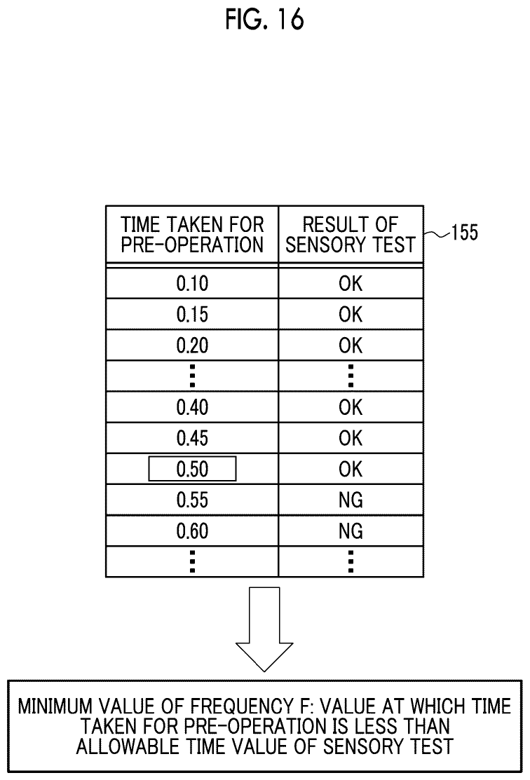

For example, as shown in FIG. 16, frequencies F of the first drive waveform 136 and the second drive waveform 137 need to be larger higher a value at which a time taken for the pre-operation is less than an allowable time value of a sensory test shown in Table 155. That is, the frequencies F of the first drive waveform 136 and the second drive waveform 137 are set according to a result of the sensory test for a time taken for the pre-operation.

The sensory test shown in Table 155 is a test in which a time taken for the pre-operation is increased from 0.1 seconds in increments of 0.05 seconds, a plurality of subjects are asked to answer whether or not the time has an acceptable length, and a result is determined as OK in a case where, for example, 90% of the subjects answer that the time is acceptable. FIG. 16 illustrates a case where the allowable time value is 0.50 seconds. In this case, the frequencies F of the first drive waveform 136 and the second drive waveform 137 need to be higher than 2 Hz.

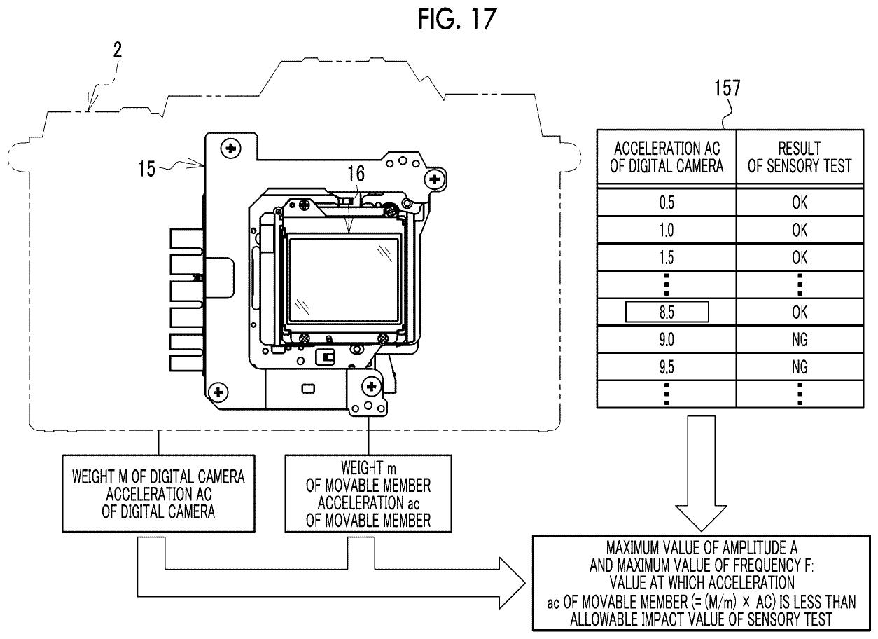

For example, as shown in FIG. 17, the amplitudes A of the first drive waveform 136 and the second drive waveform 137 need to be smaller than a value at which an acceleration AC of the digital camera 2 in the pre-operation is less than an allowable impact value of a sensory test shown in Table 157. Similarly, the frequencies F of the first drive waveform 136 and the second drive waveform 137 need to be lower than a value at which the acceleration AC of the digital camera 2 in the pre-operation is less than the allowable impact value of the sensory test shown in Table 157. That is, the amplitudes A and the frequencies F of the first drive waveform 136 and the second drive waveform 137 are set according to a result of the sensory test for an impact caused by the pre-operation.

The sensory test shown in Table 157 is a test in which the acceleration AC of the digital camera 2 in the pre-operation is increased from 0.5 mm/s² in increments of 0.5, a plurality of subjects are asked to answer whether or not an impact caused by the acceleration AC has an acceptable magnitude, and a result is determined as OK in a case where, for example, 90% of the subjects answer that the impact is acceptable. FIG. 17 illustrates a case where the allowable impact value is 8.5 mm/s².

An acceleration ac of the movable member 31 in the pre-operation can be represented by the following Equation (1) from the law of action and reaction, using the acceleration AC of the digital camera 2 in the pre-operation in a case where the weight of the digital camera 2 is denoted by M and the weight of the movable member 31 is denoted by m.

$$ac = ( M / m ) \times AC \qquad ( 1 )$$

The allowable impact value of the sensory test is substituted into AC of Expression (1) and the weight of the digital camera 2 and the weight of the movable member 31 are further substituted into Expression (1), so that the acceleration ac of the movable member 31 is calculated. Then, the amplitudes A and the frequencies F of the first drive waveform 136 and the second drive waveform 137 are set so that the acceleration ac of the movable member 31 in the pre-operation is less than the calculated acceleration ac of the movable member 31.

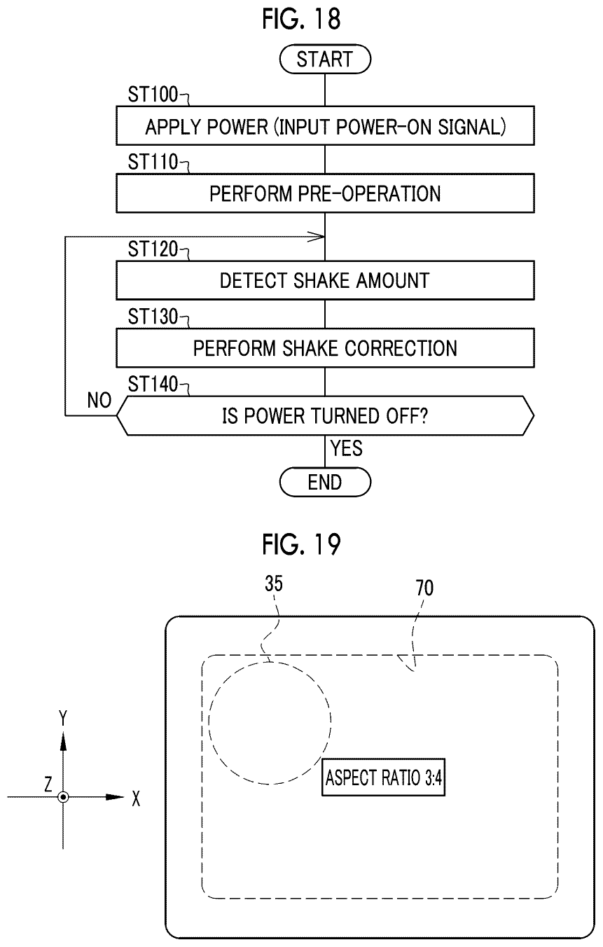

Next, an action of the above-described configuration will be described with reference to a flowchart shown in FIG. 18 as an example. As shown in FIG. 7, the CPU 131 of the control unit 18 functions as the shake correction control unit 140 as the operation program 135 is activated.

In a case where the power switch 143 is operated by a user and power is applied to the digital camera 2, a power-ON signal 144 is input to the shake correction control unit 140 from the power switch 143 (Step ST100). Then, the pre-operation using the set trajectory 150 shown in FIGS. 13 and 14 is performed according to the first drive waveform 136 and the second drive waveform 137 shown in FIG. 12 under the control of the shake correction control unit 140 (Step ST110). Due to this pre-operation, the ball 35 having been in contact with the wall surface of the housing portion 70 is moved to a position away from the wall surface of the housing portion 70 and is stopped. For this reason, it is possible to reduce a concern that the malfunction shown in FIG. 8 in which the movable member 31 cannot follow a position defined by the control signal 142 may occur, in the subsequent shake correction control.

After the pre-operation is performed, a shake amount 141 starts to be detected by the gyroscopes 126 (Step ST120). The shake amount 141 is output to the shake correction control unit 140 from the gyroscope 126.

Shake correction control corresponding to the shake amount 141 is performed by the shake correction control unit 140 (Step ST130). Specifically, in the shake correction control unit 140, a control signal 142 corresponding to the shake amount 141 is generated and the generated control signal 142 is output to the shake correction driver 110 from the shake correction control unit 140. Accordingly, the movable member 31 is moved to the position defined by the control signal 142.

The processing of Step ST120 and Step ST130 is repeated and continued as long as a user does not operate the power switch 143 to turn off the power of the digital camera 2 (NO in Step ST140).

As described above, the shake correction device 19 comprises the stationary member 30 that is fixed to the camera body 10 of the digital camera 2, the movable member 31, the housing portions 70, and the shake correction control unit 140. The imaging element 16 is mounted on the movable member 31, and the movable member 31 is disposed to face the stationary member 30 with the balls 35 interposed therebetween. The movable member 31 is moved relative to the stationary member 30 according to the rolling of the balls 35 to perform shake correction. The housing portions 70 are provided on the movable member 31 and house the balls 35 to allow the balls 35 to roll. The shake correction control unit 140 performs an operation of moving the movable member 31 along the set trajectory 150, which is a non-circular trajectory, for at least one period as a pre-operation of the shake correction. The set trajectory 150, which is a non-circular trajectory, is a trajectory in which an impact is smaller than an impact generated in the set trajectory 150C formed of the circular trajectory 151C and the linear trajectory 152C in the related art. Therefore, the pre-operation for reducing a concern that a malfunction of shake correction caused by the position of the ball 35 in the housing portion 70 may occur can be performed with a smaller impact than in the related art.

As shown in FIGS. 13 and 14, the set trajectory 150 is a trajectory which is other than the circular trajectory 151C centered on the movement origin MO of the movable member 31 and in which the amount of change in angle is smaller than that in a case where the movable member 31 reaches the circular trajectory 151C from the movement origin MO in the shortest distance and is moved along the circular trajectory 151C. Therefore, the pre-operation for reducing a concern that a malfunction of shake correction caused by the position of the ball 35 in the housing portion 70 may occur can be performed with a smaller impact than in the related art.

The movable member 31 is moved relative to the stationary member 30 in the X-axis direction and the Y-axis direction according to the rolling of the balls 35 to perform shake correction. As shown in FIG. 12 and the like, the shake correction control unit 140 performs an operation of moving the movable member 31 in the X-axis direction according to the first drive waveform 136 and moving the movable member 31 in the Y-axis direction according to the second drive waveform 137 corresponding to the first drive waveform 136, as the pre-operation. For this reason, the pre-operation can be performed using the configuration for performing shake correction as it is.

As shown in FIGS. 13 and 14, the set trajectory 150 is an oblique linear trajectory that is inclined with respect to the X-axis direction and the Y-axis direction. For this reason, the pre-operation can be performed along a very simple trajectory.

As shown in FIGS. 13 and 14, the set trajectory 150 is a trajectory passing through the movement origin MO. For this reason, an unnecessary trajectory, such as a linear trajectory 152C reaching the circular trajectory 151C from the movement origin MO and returning to the movement origin MO from the circular trajectory 151C, does not need to be inserted unlike in the set trajectory 150C in the related art. Therefore, a time taken for the pre-operation can be reduced as compared to the related art.

As shown in FIG. 4, each housing portion 70 has a square shape of which two sides orthogonal to each other have the same length and are along the X-axis direction and the Y-axis direction in a plan view. As shown in FIGS. 13 and 14, the set trajectory 150 is an oblique linear trajectory that is inclined by an angle of 45° with respect to the X-axis direction and the Y-axis direction along a diagonal line of the square housing portion 70. For this reason, a pre-operation corresponding to the shape of the housing portion 70 can be performed.

As shown in FIG. 15, the amplitudes A of the first drive waveform 136 and the second drive waveform 137 are set according to the control movable range CMR. For this reason, it is possible to reduce a concern that a problem that a state where the ball 35 is in contact with the wall surface of the housing portion 70 is not resolved even though the pre-operation is performed may occur.

As shown in FIG. 17, the amplitudes A of the first drive waveform 136 and the second drive waveform 137 are set according to a result of the sensory test for an impact caused by the pre-operation. Further, the frequencies F of the first drive waveform 136 and the second drive waveform 137 are also set according to a result of the sensory test for an impact caused by the pre-operation. For this reason, it is possible to reduce a concern that a user may feel uncomfortable due to an impact caused by the pre-operation.

As shown in FIG. 16, the frequencies F of the first drive waveform 136 and the second drive waveform 137 are set according to a result of the sensory test for a time taken for the pre-operation. For this reason, it is possible to reduce a concern that a user may feel uncomfortable or may miss a shutter chance due to an excessively long time taken for the pre-operation.

As shown in FIG. 12, the first drive waveform 136 and the second drive waveform 137 are sine waves. Since the sine wave is the most general and commonly used waveform, the pre-operation can be easily performed.

As shown in FIG. 7, the shake correction control unit 140 performs the pre-operation in a case where power is applied to the digital camera 2. For this reason, a user can use the shake correction function without worrying about a malfunction immediately after power is applied.

The movement origin MO of the movable member 31 is the center CCM of the control movable range CMR. More specifically, the movement origin MO of the movable member 31 is an optical center CL of the lens 100 of the digital camera 2 and the center CM of the mount portion 11 on which the lens 100 is mounted. For this reason, a smooth transition to a normal imaging operation can be made after the pre-operation is performed.

The center CCM of the control movable range CMR, the optical center CL of the lens 100 of the digital camera 2, and the center CM of the mount portion 11 on which the lens 100 is mounted coincide with each other in this example, but the present disclosure is not limited thereto. The center CCM of the control movable range CMR, the optical center CL of the lens 100 of the digital camera 2, and the center CM of the mount portion 11 on which the lens 100 is mounted may not coincide with each other. The movement origin MO of the movable member 31 may be at least one of the center CCM of the control movable range CMR, the optical center CL of the lens 100 of the digital camera 2, or the center CM of the mount portion 11 on which the lens 100 is mounted.

### Modification Example 1_1

For example, as shown in FIG. 19, the housing portion 70 is not limited to a square shape and may have a rectangular shape of which two sides orthogonal to each other are along the X-axis direction and the Y-axis direction. A rectangular housing portion 70 having an aspect ratio (a ratio between a side along the Y-axis direction and a side along the X-axis direction) of 3:4 is illustrated in FIG. 19.

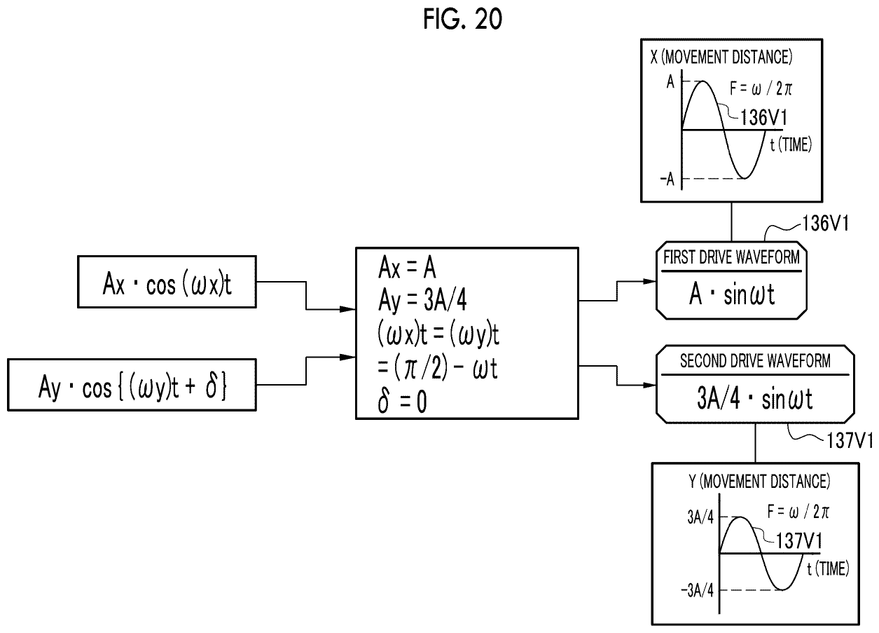

For example, as shown in FIG. 20, in the case of the housing portion 70 shown in FIG. 19, Ax is set to A, Ay is set to 3A/4, (ωx)t and (ωy)t are set to (π/2)−ωt, and δ is set to 0. For this reason, a first drive waveform 136V1 is A·sin ωt and a second drive waveform 137V1 is 3A/4·sin ωt. More specifically, the first drive waveform 136V1 is a one-period portion of A·sin ωt and the second drive waveform 137V1 is a one-period portion of 3A/4 sin ωt.

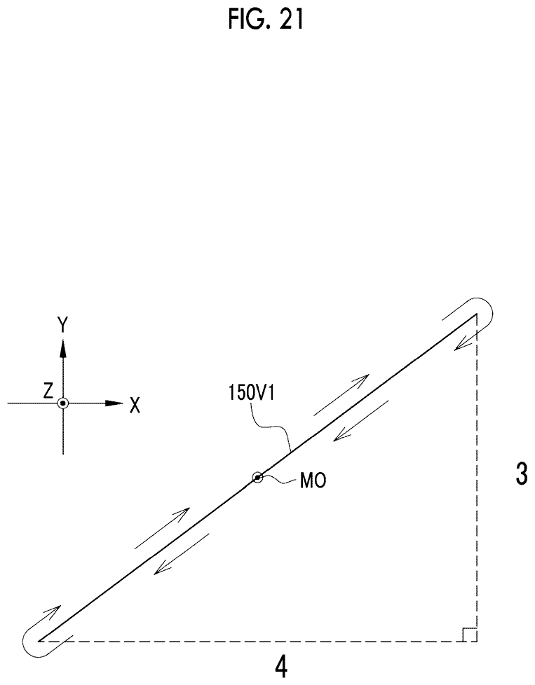

For example, as shown in FIG. 21, a set trajectory 150V1 in the pre-operation in the case of the housing portion 70 shown in FIG. 19 is a trajectory that passes through the movement origin MO, and is an oblique linear trajectory that is inclined with respect to the X-axis direction and the Y-axis direction along a diagonal line of the rectangular housing portion 70. In other words, the set trajectory 150V1 is an oblique linear trajectory along a diagonal line of a rectangle having the same aspect ratio of 3:4 as the housing portion 70. The set trajectory 150V1 is a trajectory that is generated from a one-period portion of A·sin ωt of the first drive waveform 136V1 and a one-period portion of 3A/4 sin ωt of the second drive waveform 137V1. That is, the set trajectory 150V1 is also a type of a Lissajous figure. In a case where a ratio between the amplitude of the first drive waveform 136V1 and the amplitude of the second drive waveform 137V1 is changed as described above, the set trajectory 150V1 corresponding to the rectangular housing portion 70 can be obtained.

### Modification Example 1_2

Although oblique linear trajectories have been exemplified as the set trajectory 150 and the set trajectory 150V1, the set trajectory 150 and the set trajectory 150V1 are not limited thereto as long as being non-circular trajectories. The following description is an example of not the rectangular housing portion 70 shown in FIG. 19 but the square housing portion 70 shown in FIG. 4.

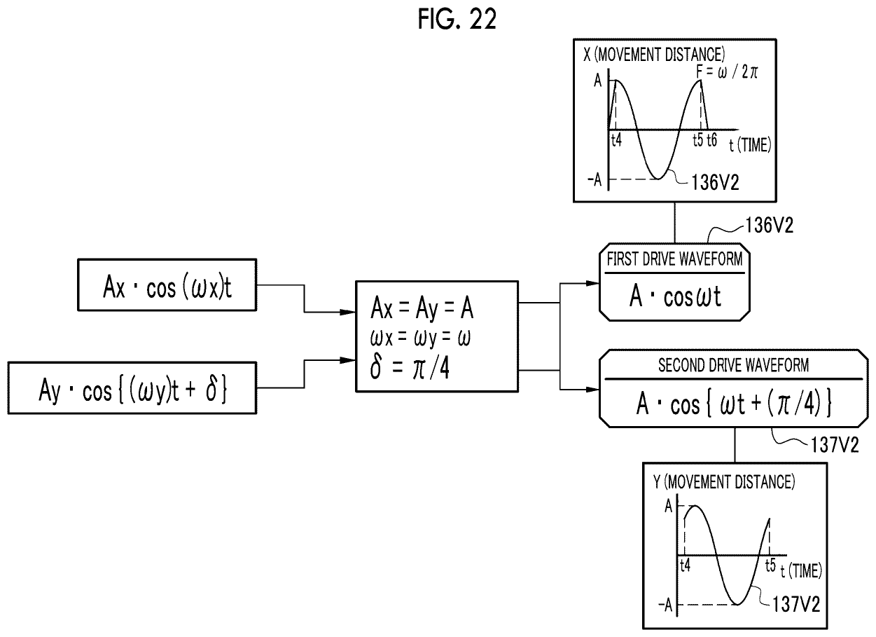

For example, as shown in FIG. 22, in Modification Example 1_2, Ax and Ay are set to A, ωx and ωy are set to ω, and δ is set to π/4. For this reason, a first drive waveform 136V2 is A·cos ωt and a second drive waveform 137V2 is A·cos{ωt+(π/4)}. More specifically, the first drive waveform 136V2 is a one-period portion of A·cos(ωt) and the second drive waveform 137V2 is a one-period portion of A·cos{ωt+(π/4)}.

More specifically, the first drive waveform 136V2 is a composite waveform of a one-period portion of A·cost, a straight line having a gradient of A/t4, and a straight line having a gradient of −A/(t6−t5). Further, more accurately, the second drive waveform 137V2 is a one-period portion of A·cos{ωt+(π/4)} of which a start time is t4 and an end time is t5. t4 and (t6−t5) have the same value, and are, for example, several tens to several hundreds of milliseconds.

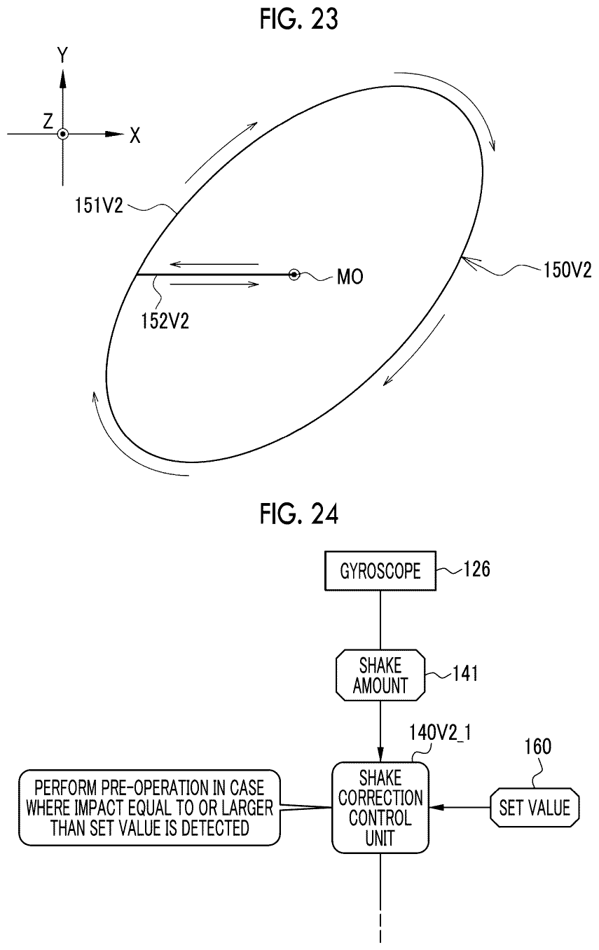

For example, as shown in FIG. 23, a set trajectory 150V2 in the pre-operation of Modification Example 1_2 is formed of an oblique elliptical trajectory 151V2 which is centered on the movement origin MO and of which a major axis and a minor axis are inclined by an angle of 45° with respect to the X-axis direction and the Y-axis direction, and a linear trajectory 152V2 that reaches the elliptical trajectory 151V2 from the movement origin MO, reaches the movement origin MO from the elliptical trajectory 151V2, and is parallel to the X-axis direction. The elliptical trajectory 151V2 is a trajectory that is generated from a one-period portion of A·cos ωt of the first drive waveform 136V2 and a one-period portion of A·cos{ωt+(π/4)} of the second drive waveform 137V2. That is, the elliptical trajectory 151V2 is also a type of a Lissajous figure.

The elliptical trajectory 151V2 is a trajectory that allows the movable member 31 to move without a deviation in a movement distance in the vertical and horizontal directions. The linear trajectory 152V2 is a trajectory that is generated from a straight line having a gradient of A/t4 of the first drive waveform 136V2 and a straight line having a gradient of −A/(t6−t5).

As described above, the set trajectory 150V2 may be an oblique elliptical trajectory that is inclined with respect to the X-axis direction and the Y-axis direction. In the set trajectory 150V2, there is no large change in the angle, such as a change in the angle close to 90° in the case of the set trajectory 150C in the related art. For this reason, since it can be said that the set trajectory 150V2 is also a trajectory in which the amount of change in the angle is smaller than that of the set trajectory 150C, the pre-operation can be performed with a smaller impact than that in the related art. In a case where a ratio between the amplitude Ax of the first drive waveform 136V2 and the amplitude Ay of the second drive waveform 137V2 is changed, the lengths of the major axis and the minor axis of the ellipse of the set trajectory 150V2 and the angles of the major axis and the minor axis with respect to the X-axis direction and the Y-axis direction can be changed.

A trajectory in which the linear trajectory 152C is changed into a semicircular trajectory or a semi-elliptical trajectory in the set trajectory 150C in the related art to relax a change in the angle in a case where the movable member 31 is moved to the circular trajectory 151C from the semicircular trajectory or the semi-elliptical trajectory and a case where the movable member 31 is moved to the semicircular trajectory or the semi-elliptical trajectory from the circular trajectory 151C may be employed as the set trajectory 150. However, since the linear trajectory 152C is changed into the semicircular trajectory or the semi-elliptical trajectory in this case, a time taken for the pre-operation is increased.

### Modification Example 2_1

A timing at which the pre-operation is performed is not limited to a case where power is applied to the digital camera 2 as exemplified in the above-described embodiment. For example, as in a shake correction control unit 140V2_1 shown in FIG. 24, the pre-operation may be performed in a case where the shake amount 141 detected by the gyroscope 126 is equal to or larger than a set value 160. The case where the shake amount 141 detected by the gyroscope 126 is equal to or larger than the set value 160 is an example of “a case where an impact equal to or larger than a set value is detected” according to the technique of the present disclosure. The set value 160 is stored in the storage 130 and is input to the shake correction control unit 140V2_1. A value at which a probability that the ball 35 positioned at the center of the housing portion 70 comes into contact with the wall surface of the housing portion 70 due to the rebound of an impact is, for example, 50% or more is set as the set value 160.

As described above, the shake correction control unit 140V2_1 performs the pre-operation in a case where an impact equal to or larger than the set value 160 is detected. For this reason, the ball 35 that has been in contact with the wall surface of the housing portion 70 can be moved to a position away from the wall surface of the housing portion 70 by the impact equal to or larger than the set value 160.

### Modification Example 2_2

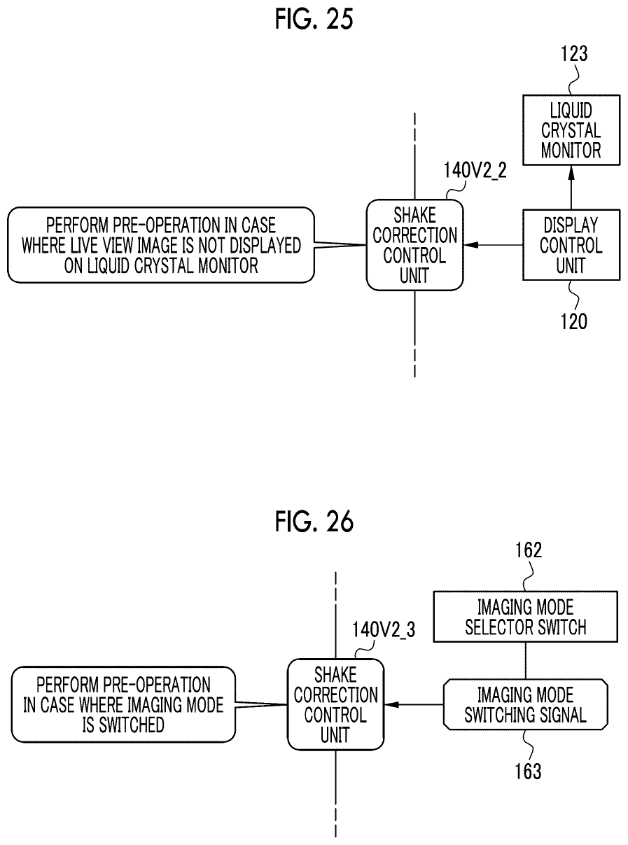

For example, as shown in FIG. 25, the display control unit 120 is connected to a shake correction control unit 140V2_2 of Modification Example 2_2. Information indicating whether or not a live view image is displayed on the liquid crystal monitor 123 is input to the shake correction control unit 140V2_2 from the display control unit 120. The shake correction control unit 140V2_2 performs the pre-operation in a case where a live view image is not displayed on the liquid crystal monitor 123. The case where a live view image is not displayed on the liquid crystal monitor 123 is, for example, a case where a user gives an instruction to stop displaying the live view image on the liquid crystal monitor 123, a case where a preview of a captured image is displayed on the liquid crystal monitor 123 by the pressing of the release button, or the like.

As described above, the shake correction control unit 140V2_2 performs the pre-operation in a case where a live view image is not displayed on the liquid crystal monitor 123. For this reason, since a user visually recognizes that the pre-operation is being performed with the motion of a live view image, it is possible to avoid that the user feels uncomfortable or suspects a failure.

### Modification Example 2_3

For example, as shown in FIG. 26, an imaging mode selector switch 162 is connected to a shake correction control unit 140V2_3 of Modification Example 2_3. The shake correction control unit 140V2_3 performs the pre-operation in a case where a user operates the imaging mode selector switch 162 to switch an imaging mode and an imaging mode switching signal 163 is input from the imaging mode selector switch 162. That is, the shake correction control unit 140V2_3 performs the pre-operation in a case where an imaging mode is switched. The case where an imaging mode is switched is, for example, a case where an imaging mode is switched to the video capturing mode from the static image capturing mode, a case where an imaging mode is switched to the static image capturing mode from the video capturing mode, or the like.

As described above, the shake correction control unit 140V2_3 performs the pre-operation in a case where an imaging mode is switched. For this reason, a user can use the shake correction function without worrying about a malfunction immediately after an imaging mode is switched.

### Modification Example 2_4

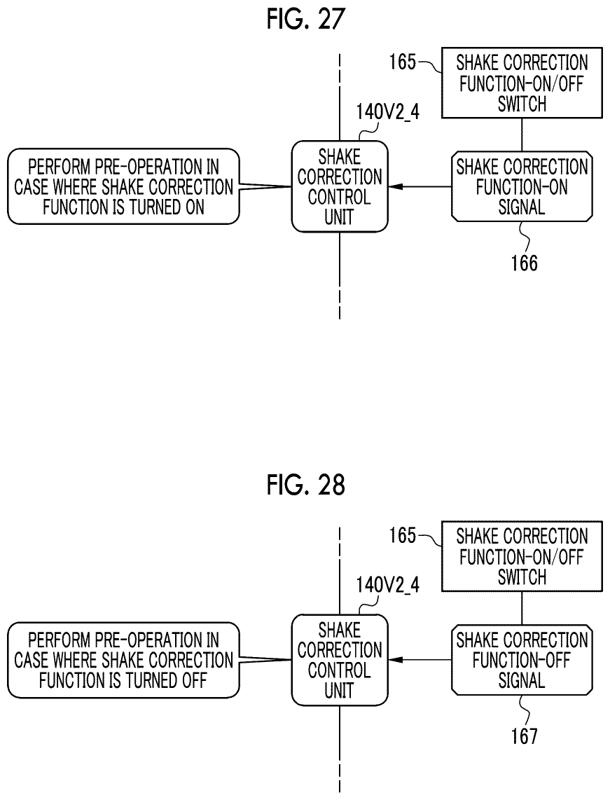

For example, as shown in FIG. 27, a shake correction function-ON/OFF switch 165 is connected to a shake correction control unit 140V2_4 of Modification Example 2_4. The shake correction control unit 140V2_4 performs the pre-operation in a case where a user operates the shake correction function-ON/OFF switch 165 to turn on the shake correction function and a shake correction function-ON signal 166 is input from the shake correction function-ON/OFF switch 165. That is, the shake correction control unit 140V2_4 performs the pre-operation in a case where the shake correction function is turned on. For this reason, a user can use the shake correction function without worrying about a malfunction.

For example, as shown in FIG. 28, the shake correction control unit 140V2_4 may perform the pre-operation in a case where a user operates the shake correction function-ON/OFF switch 165 to turn off the shake correction function and a shake correction function-OFF signal 167 is input from the shake correction function-ON/OFF switch 165, that is, in a case where the shake correction function is turned off, instead of or in addition to a case where the shake correction function is turned on. In a case where the pre-operation is performed in a case where the shake correction function is turned off, a state where the ball 35 is in contact with the wall surface of the housing portion 70 in a case where the shake correction function is turned off can be immediately resolved.

### Modification Example 2_5

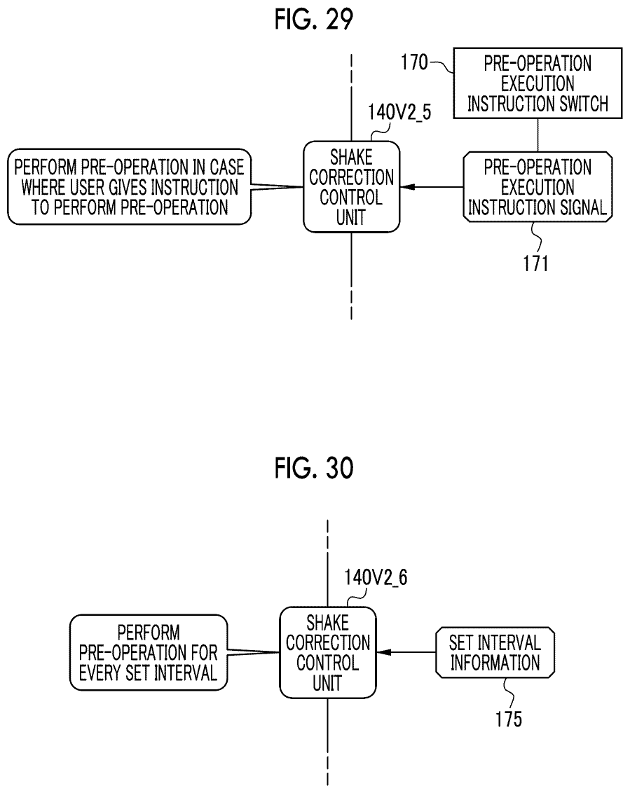

For example, as shown in FIG. 29, a pre-operation execution instruction switch 170 is connected to a shake correction control unit 140V2_5 of Modification Example 2_5. The shake correction control unit 140V2_5 performs the pre-operation in a case where a user operates the pre-operation execution instruction switch 170 to give an instruction to perform the pre-operation and a pre-operation execution instruction signal 171 is input from the pre-operation execution instruction switch 170. That is, the shake correction control unit 140V2_5 performs the pre-operation in a case where an instruction to perform the pre-operation is given. For this reason, the pre-operation can be performed at an appropriate timing at which a user wants to perform the pre-operation.

### Modification Example 2_6

For example, as shown in FIG. 30, set interval information 175 is input to a shake correction control unit 140V2_6 of Modification Example 2_6. The set interval information 175 is information on an interval which is set in advance and at which the pre-operation is performed, and is stored in the storage 130. The set interval is, for example, several tens of seconds to several minutes. The shake correction control unit 140V2_6 performs the pre-operation for every set interval of the set interval information 175. For this reason, the pre-operation can be performed without causing a user to be troubled as in Modification Example 2_3, Modification Example 2_4, and Modification Example 2_5. The set interval may be configured such that a user can change the set interval.

An aspect in which the pre-operation is performed in a case where power is applied to the digital camera 2 of the above-described embodiment, and Modification Examples 2_1 to 2_6 may be performed in combination. For example, the pre-operation may be performed in a case where Modification Examples 2_1, 2_2, and 2_6 are performed in combination and an impact equal to or larger than the set value 160 is detected, a case where a live view image is not displayed on the liquid crystal monitor 123, and for every set interval.

The imaging mode selector switch 162 of Modification Example 2_3, the shake correction function-ON/OFF switch 165 of Modification Example 2_4, and the pre-operation execution instruction switch 170 of Modification Example 2_5 may be actual switches included in the operation unit 108 or may be graphical user interfaces (GUIs) displayed on the touch panel 125.

### Modification Example 3

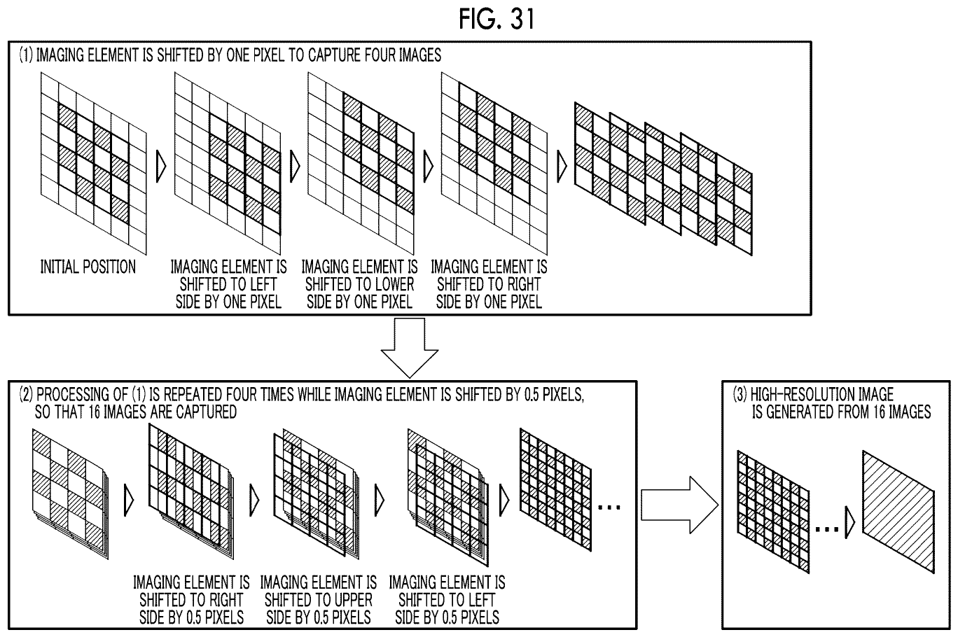

For example, as shown in FIG. 31, a special imaging mode can be performed as an imaging mode in Modification Example 3. In the special imaging mode, first, as shown in (1), an image is captured at an initial position, the imaging element 16 is then shifted from the initial position to the left side, the lower side, and the right side by one pixel using the shake correction function, and an image is captured at each shifted position, so that four images are captured. Next, as shown in (2), the processing of (1) is repeated four times while the imaging element 16 is shifted to the right side, the upper side, and the left side by 0.5 pixels using the shake correction function, so that a total of 16 images are captured. Then, as shown in (3), one high-resolution image is generated from the 16 images. This special imaging mode is also referred to as a pixel shift mode.

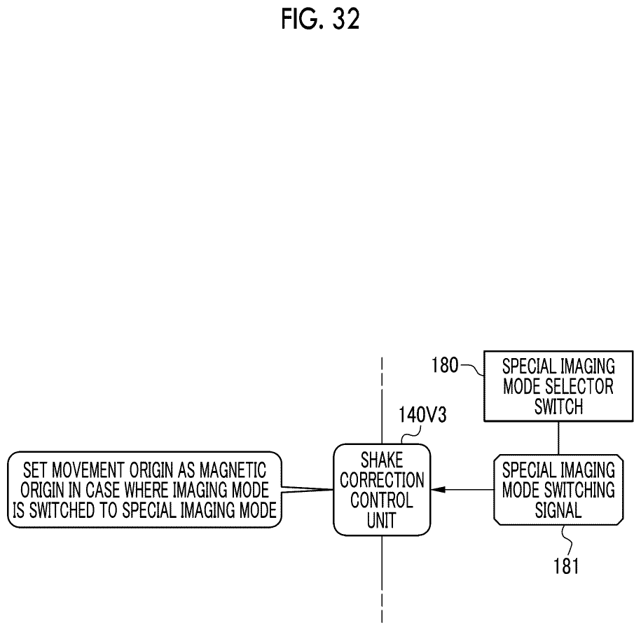

For example, as shown in FIG. 32, a special imaging mode selector switch 180 is connected to a shake correction control unit 140V3 of Modification Example 3. In a case where a user operates the special imaging mode selector switch 180 to switch an imaging mode to the special imaging mode and a special imaging mode switching signal 181 is input from the special imaging mode selector switch 180, the shake correction control unit 140V3 sets the movement origin MO of the movable member 31 as a magnetic origin. The magnetic origin is a position at which an influence of the magnetic fields of the first VCM and the second VCM of the shake correction unit 15 is relatively small.

As described above, in Modification Example 3, the movement origin MO of the movable member 31 is a magnetic origin that is a position at which an influence of the magnetic fields of the first VCM and the second VCM is relatively small. For this reason, the pre-operation and the shake correction control can be performed from the magnetic origin at which the minute movement of the movable member 31 is less likely to be hindered.

The special imaging mode can be performed in Modification Example 3. The special imaging mode is a mode in which the movable member 31 is moved to a plurality of positions by a short movement distance in units of pixels of the imaging element 16, images are captured at the plurality of positions, and a high-resolution image is generated from the plurality of obtained images. The shake correction control unit 140V3 sets the movement origin as the magnetic origin in a case where an imaging mode is switched to the special imaging mode. For this reason, the special imaging mode can be smoothly performed without stress as compared to a case where the movement origin is not the magnetic origin.

The magnetic origin may coincide with or be different from at least one of the center CCM of the control movable range CMR, the center CL of the lens 100, or the center CM of the mount portion 11. Further, the special imaging mode selector switch 180 may be an actual switch included in the operation unit 108 or may be a GUI displayed on the touch panel 125.

The first drive waveform 136 and the second drive waveform 137 may be waveforms corresponding to two or more periods.

Further, the first drive waveform 136 and the second drive waveform 137 are not limited to the illustrated sine waves. The first drive waveform 136 and the second drive waveform 137 may be triangular waves, square waves, sawtooth waves, or the like. The first drive waveform 136 and the second drive waveform 137 may be waveforms in which corners of a triangular wave, a square wave, a sawtooth wave, or the like are rounded.

The control movable range CMR may have a circular shape. In a case where the control movable range CMR has a circular shape, D that defines the minimum value of the amplitudes A of the first drive waveform 136 and the second drive waveform 137 is a radius of the control movable range CMR.

Although the liquid crystal monitor 123 provided on the rear surface of the camera body 10 has been exemplified as a monitor that displays a live view image, the present disclosure is not limited thereto. An electronic viewfinder through which a user looks may be provided instead of or in addition to the liquid crystal monitor 123.

Although the plates 45 have been provided on the stationary member 30 and the housing portions 70 have been provided on the movable member 31 in the above-described embodiment, but the present disclosure is not limited thereto. The plates 45 may be provided on the movable member 31, and the housing portions 70 may be provided on the stationary member 30. Further, although the magnets 40 to 42 have been provided on the stationary member 30 and the coils 60 to 62 have been provided on the movable member 31 in the above-described embodiment, but the present disclosure is not limited thereto. The magnets 40 to 42 may be provided on the movable member 31 and the coils 60 to 62 may be provided on the stationary member 30. Furthermore, the number of the sets of the balls 35, the plates 45, and the housing portions 70 is not limited to three and may be four or more.

The shake correction unit according to the embodiment of the present disclosure can also be applied to an imaging apparatus other than the exemplified digital camera 2, for example, a smartphone, a tablet terminal, a monitoring camera, or the like.

In the above-described embodiment, for example, various processors to be described below can be used as the hardware structures of processing units, which perform various types of processing, such as the shake correction control units 140, 140V2_1 to 140V2_6, and 140V3. The various processors include a programmable logic device (PLD) that is a processor of which the circuit configuration can be changed after manufacture, such as a field programmable gate array (FPGA), a dedicated electrical circuit that is a processor having a circuit configuration designed exclusively to perform specific processing, such as an Application Specific Integrated Circuit (ASIC), and the like in addition to the CPU 131 that is a general-purpose processor executing software (operation program 135) to function as various processing units as described above.

One processing unit may be formed of one of these various processors, or may be formed of a combination of two or more processors of the same type or different types (for example, a combination of a plurality of FPGAs and/or a combination of a CPU and an FPGA). Further, a plurality of processing units may be formed of one processor.

As an example where a plurality of processing units are formed of one processor, first, there is an aspect in which one processor is formed of a combination of one or more CPUs and software as typified by a computer, such as a client or a server, and functions as a plurality of processing units. Second, there is an aspect in which a processor realizing the functions of the entire system, which includes a plurality of processing units, by one integrated circuit (IC) chip as typified by System On Chip (SoC) or the like is used. In this way, various processing units are formed using one or more of the above-described various processors as hardware structures.

In addition, more specifically, electrical circuitry where circuit elements, such as semiconductor elements, are combined can be used as the hardware structures of these various processors.

From the above description, it is possible to ascertain techniques described in the following supplementary claims.

### [Supplementary Claim 1]

A shake correction device including:
a stationary member that is fixed to a body of an imaging apparatus;
a movable member on which an imaging element is mounted and which is disposed to face the stationary member with a ball interposed therebetween and is moved relative to the stationary member according to rolling of the ball to perform shake correction;
an housing portion that is provided on at least one of the stationary member or the movable member and houses the ball to allow the ball to roll; and
a processor,
wherein the processor performs an operation of moving the movable member along a set trajectory, which is a non-circular trajectory, for at least one period as a pre-operation of the shake correction.

### [Supplementary Claim 2]

The shake correction device according to supplementary claim 1,
wherein the set trajectory is a trajectory which is other than a circular trajectory centered on a movement origin of the movable member and in which an amount of change in angle is smaller than that in a case where the movable member reaches the circular trajectory from the movement origin in a shortest distance and is moved along the circular trajectory.

### [Supplementary Claim 3]

The shake correction device according to supplementary claim 2,
wherein the movable member is moved relative to the stationary member in a first direction and a second direction intersecting the first direction according to the rolling of the ball to perform the shake correction, and
the processor performs an operation of moving the movable member in the first direction according to a first drive waveform and moving the movable member in the second direction according to a second drive waveform corresponding to the first drive waveform, as the pre-operation.

### [Supplementary Claim 4]

The shake correction device according to supplementary claim 3,
wherein the set trajectory is an oblique linear trajectory inclined with respect to the first direction and the second direction.

### [Supplementary Claim 5]

The shake correction device according to supplementary claim 3 or 4,
wherein the set trajectory is a trajectory passing through the movement origin.

### [Supplementary Claim 6]

The shake correction device according to any one of supplementary claims 3 to 5,
wherein the housing portion has a rectangular shape of which two sides orthogonal to each other are along the first direction and the second direction in a plan view, and
the set trajectory is an oblique linear trajectory along a diagonal line of the rectangular housing portion.

### [Supplementary Claim 7]

The shake correction device according to any one of supplementary claims 3 to 5,
wherein the housing portion has a square shape of which two sides orthogonal to each other have the same length and are along the first direction and the second direction in a plan view, and
the set trajectory is an oblique linear trajectory that is inclined by an angle of 45° with respect to the first direction and the second direction along a diagonal line of the square housing portion.

### [Supplementary Claim 8]

The shake correction device according to supplementary claim 3,
wherein the set trajectory is an oblique elliptical trajectory inclined with respect to the first direction and the second direction.

### [Supplementary Claim 9]

The shake correction device according to any one of supplementary claims 3 to 8,
wherein amplitudes of the first drive waveform and the second drive waveform are set according to a range in which the movable member is movable under a control of the processor.

### [Supplementary Claim 10]

The shake correction device according to any one of supplementary claims 3 to 9,
wherein amplitudes of the first drive waveform and the second drive waveform are set according to a result of a sensory test for an impact applied by the pre-operation.

### [Supplementary Claim 11]

The shake correction device according to any one of supplementary claims 3 to 10,
wherein frequencies of the first drive waveform and the second drive waveform are set according to a result of a sensory test for a time taken for the pre-operation.

### [Supplementary Claim 12]

The shake correction device according to any one of supplementary claims 3 to 11,
wherein frequencies of the first drive waveform and the second drive waveform are set according to a result of a sensory test for an impact applied by the pre-operation.

### [Supplementary Claim 13]

The shake correction device according to any one of supplementary claims 3 to 12,
wherein the first drive waveform and the second drive waveform are sine waves.

### [Supplementary Claim 14]

The shake correction device according to any one of supplementary claims 1 to 13,
wherein the processor performs the pre-operation at at least one timing of a case where power is applied to the imaging apparatus, a case where an impact equal to or larger than a set value is detected, a case where a live view image is not displayed on a monitor of the imaging apparatus, a case where an imaging mode is switched in the imaging apparatus, a case where a function of the shake correction is turned on and/or off in the imaging apparatus, a case where an instruction to perform the pre-operation is given by a user, and every set interval.

### [Supplementary Claim 15]

The shake correction device according to any one of supplementary claims 1 to 14,
wherein a movement origin of the movable member is at least one of a center of a range in which the movable member is movable under a control of the processor, an optical center of a lens of the imaging apparatus, or a center of a mount portion on which the lens is mounted.

### [Supplementary Claim 16]

The shake correction device according to any one of supplementary claims 1 to 15,
wherein the movable member is capable of being moved by a voice coil motor, and
a movement origin of the movable member is a magnetic origin that is a position at which an influence of a magnetic field of the voice coil motor is relatively small.

### [Supplementary Claim 17]

The shake correction device according to supplementary claim 16,
wherein the imaging apparatus has a special imaging mode in which the movable member is moved to a plurality of positions by a short movement distance in units of pixels of the imaging element, images are captured at the plurality of positions, and a high-resolution image is generated from the plurality of obtained images, and
the processor sets the movement origin as the magnetic origin in a case where an imaging mode is switched to the special imaging mode in the imaging apparatus.

### [Supplementary Claim 18]

An imaging apparatus comprising:
the shake correction device according to any one of supplementary claims 1 to 17.

Various embodiments and/or various modification examples described above can also be appropriately combined in the technique of the present disclosure. Further, it goes without saying that the present disclosure is not limited to the embodiments and can employ various configurations without departing from a gist.

The above described contents and illustrated contents are detailed descriptions for parts according to the disclosed technique and are merely an example of the disclosed technique. For example, the description of the configuration, functions, actions, and effects having been described above is the description of examples of the configuration, functions, actions, and effects of the portions according to the technique of the present disclosure. Accordingly, it goes without saying that unnecessary portions may be deleted or new elements may be added or replaced in the description contents and shown contents described above without departing from the scope of the technique of the present disclosure. In addition, particularly, description related to common technical knowledge or the like that does not need to be described in terms of embodying the disclosed technique is omitted in the above described contents and the illustrated contents in order to avoid complication and to facilitate understanding of the parts according to the disclosed technique.

In this specification, “A and/or B” is synonymous with “at least one of A or B”. That is, “A and/or B” may mean only A, may mean only B, or may mean a combination of A and B. In addition, in this specification, the same approach as “A and/or B” is applied to a case where three or more matters are represented by connecting the matters with “and/or”.

All documents, patent applications, and technical standards described in this specification are incorporated in this specification by reference to the same extent as in a case where each of the documents, the patent applications, and the technical standards are specifically and individually indicated to be incorporated by reference.

What is claimed is:

1. A shake correction device comprising:
a stationary member that is fixed to a body of an imaging apparatus;
a movable member on which an imaging element is mounted and which is disposed to face the stationary member with a ball interposed therebetween and is moved relative to the stationary member according to rolling of the ball to perform shake correction;
an housing portion that is provided on at least one of the stationary member or the movable member and houses the ball to allow the ball to roll; and
a processor,
wherein the processor performs an operation of moving the movable member along a set trajectory, which is a non-circular trajectory, for at least one period as a pre-operation of the shake correction.

2. The shake correction device according to claim 1,
wherein the set trajectory is a trajectory which is other than a circular trajectory centered on a movement origin of the movable member and in which an amount of change in angle is smaller than that in a case where the movable member reaches the circular trajectory from the movement origin in a shortest distance and is moved along the circular trajectory.

3. The shake correction device according to claim 2,
wherein the movable member is moved relative to the stationary member in a first direction and a second direction intersecting the first direction according to the rolling of the ball to perform the shake correction, and
the processor performs an operation of moving the movable member in the first direction according to a first drive waveform and moving the movable member in the second direction according to a second drive waveform corresponding to the first drive waveform, as the pre-operation.

4. The shake correction device according to claim 3,
wherein the set trajectory is an oblique linear trajectory inclined with respect to the first direction and the second direction.

5. The shake correction device according to claim 3,
wherein the set trajectory is a trajectory passing through the movement origin.

6. The shake correction device according to claim 3,
wherein the housing portion has a rectangular shape of which two sides orthogonal to each other are along the first direction and the second direction in a plan view, and
the set trajectory is an oblique linear trajectory along a diagonal line of the rectangular housing portion.

7. The shake correction device according to claim 3,
wherein the housing portion has a square shape of which two sides orthogonal to each other have the same length and are along the first direction and the second direction in a plan view, and
the set trajectory is an oblique linear trajectory that is inclined by an angle of 45° with respect to the first direction and the second direction along a diagonal line of the square housing portion.

8. The shake correction device according to claim 3,
wherein the set trajectory is an oblique elliptical trajectory inclined with respect to the first direction and the second direction.

9. The shake correction device according to claim 3,
wherein amplitudes of the first drive waveform and the second drive waveform are set according to a range in which the movable member is movable under a control of the processor.

10. The shake correction device according to claim 3,
wherein amplitudes of the first drive waveform and the second drive waveform are set according to a result of a sensory test for an impact applied by the pre-operation.

11. The shake correction device according to claim 3,
wherein frequencies of the first drive waveform and the second drive waveform are set according to a result of a sensory test for a time taken for the pre-operation.

12. The shake correction device according to claim 3,
wherein frequencies of the first drive waveform and the second drive waveform are set according to a result of a sensory test for an impact applied by the pre-operation.

13. The shake correction device according to claim 3,
wherein the first drive waveform and the second drive waveform are sine waves.

14. The shake correction device according to claim 1,
wherein the processor performs the pre-operation at at least one timing of a case where power is applied to the imaging apparatus, a case where an impact equal to or larger than a set value is detected, a case where a live view image is not displayed on a monitor of the imaging apparatus, a case where an imaging mode is switched in the imaging apparatus, a case where a function of the shake correction is turned on and/or off in the imaging apparatus, a case where an instruction to perform the pre-operation is given by a user, and every set interval.

15. The shake correction device according to claim 1,
wherein a movement origin of the movable member is at least one of a center of a range in which the movable member is movable under a control of the processor, an optical center of a lens of the imaging apparatus, or a center of a mount portion on which the lens is mounted.

16. The shake correction device according to claim 1,
wherein the movable member is capable of being moved by a voice coil motor, and
a movement origin of the movable member is a magnetic origin that is a position at which an influence of a magnetic field of the voice coil motor is relatively small.

17. The shake correction device according to claim 16,
wherein the imaging apparatus has a special imaging mode in which the movable member is moved to a plurality of positions by a short movement distance in units of pixels of the imaging element, images are captured at the plurality of positions, and a high-resolution image is generated from the plurality of obtained images, and
the processor sets the movement origin as the magnetic origin in a case where an imaging mode is switched to the special imaging mode in the imaging apparatus.

18. An operation method for a shake correction device including a stationary member that is fixed to a body of an imaging apparatus, a movable member on which an imaging element is mounted and which is disposed to face the stationary member with a ball interposed therebetween and is moved relative to the stationary member according to rolling of the ball to perform shake correction, and an housing portion that is provided on at least one of the stationary member or the movable member and houses the ball to allow the ball to roll, the operation method comprising:
performing an operation of moving the movable member along a set trajectory, which is a non-circular trajectory, for at least one period as a pre-operation of the shake correction.

19. A non-transitory computer-readable storage medium storing an operation program for a shake correction device including a stationary member that is fixed to a body of an imaging apparatus, a movable member on which an imaging element is mounted and which is disposed to face the stationary member with a ball interposed therebetween and is moved relative to the stationary member according to rolling of the ball to perform shake correction, and an housing portion that is provided on at least one of the stationary member or the movable member and houses the ball to allow the ball to roll, the operation program causing a computer to execute processing comprising:
performing an operation of moving the movable member along a set trajectory, which is a non-circular trajectory, for at least one period as a pre-operation of the shake correction.

20. An imaging apparatus comprising:
the shake correction device according to claim 1.
